(19) United States
(12) Patent Application Publication
(10) Pub. No.: US 2021/0348616 A1
(43) Pub. Date: Nov. 11, 2021

(54) FAN MOTOR

(71) Applicant: LG Electronics Inc., Seoul (KR)

(72) Inventors: Eunji HWANG, Seoul (KR); Byungjik KIM, Seoul (KR); Sunggi KIM, Seoul (KR); Jisu HWANG, Seoul (KR)

(21) Appl. No.: 17/206,857

(22) Filed: Mar. 19, 2021

(30) Foreign Application Priority Data
May 8, 2020 (KR) 10-2020-0055281
May 18, 2020 (KR) 10-2020-0059276
May 20, 2020 (KR) 10-2020-0060476

(51) Int. Cl. F04D 25/06; F04D 29/08

(52) U.S. Cl. CPC F04D 25/062; F04D 29/083

(57) ABSTRACT

A fan motor includes a shroud, a rotating shaft that is disposed inside the shroud and includes a first support portion, a second support portion, and a permanent magnet mounting portion disposed between the first support portion and the second support portion, an impeller disposed at a first end portion of the rotating shaft, an air bearing that is disposed adjacent to the impeller and defines an air gap facing the first support portion, a permanent magnet disposed at the permanent magnet mounting portion between the first end portion and a second end portion of the rotating shaft opposite to the first end portion in the axial direction, and a ball bearing disposed at the second end portion of the rotating shaft and configured to rotatably support the second support portion.

### CROSS-REFERENCE TO RELATED APPLICATIONS

Pursuant to 35 U.S.C. § 119(a), this application claims the benefit of earlier filing dates of and the right of priority to Korean Application Nos. 10-2020-0055281, filed on May 8, 2020, 10-2020-0059276, filed on May 18, 2020, and 10-2020-0060476, filed on May 20, 2020, the contents of which are incorporated by reference herein in their entirety.

### TECHNICAL FIELD

The present disclosure relates to a fan motor suitable for high-speed rotation of a fan.

### BACKGROUND

A motor can be provided in a home appliance such as a vacuum cleaner or a hair dryer. The vacuum cleaner or the hair dryer can generate a rotational force using the motor as a power source. For example, the motor can be coupled to a fan. The fan can rotate by receiving power from the motor to generate an air current.

In some cases, the vacuum cleaner or the hair dryer may be operated while a user lifts it by hand. In order to increase the user's portability and convenience, the size and weight of the vacuum cleaner or the hair dryer can be reduced. In some cases, the high-speed rotation of the motor may be essential for certain applications.

In some cases, a motor can include a rotor assembly that includes a rotating shaft. An impeller, a rotor core and a bearing cartridge are mounted on the rotating shaft. The motor can include a bearing cartridge disposed between the impeller and the rotor core. In some examples, the bearing cartridge includes two ball bearings, a spring, and a sleeve. The bearing cartridge can support the rotating shaft with two ball bearings. The bearing cartridge can include a spring disposed between the two ball bearings, and the spring can apply a preload to each of the two ball bearings, thereby securing the life of the ball bearings. In some cases, the bearing cartridge can accommodate the two ball bearings inside the sleeve to extend the life of the ball bearings by aligning the outer ring of the ball bearings by the sleeve.

In some cases, where the two ball bearings are applied to a fan motor, it can be difficult to reduce the size and weight of the fan motor.

For example, in order to reduce the size and weight of the fan motor, a size of the ball bearing should be small, but the ball bearing has a structure in which a plurality of balls are in rolling contact between the outer ring and the inner ring. Thus, the smaller the size of the ball bearing, the greater the applied load to the bearing. The larger the size, the less suitable for a high speed rotation.

The smaller the size of the ball bearing is, the smaller the diameter of the rotating shaft is. In some cases, where the diameter of the rotating shaft is too small, the rotating shaft can bend. In some cases, a support portion of the rotating shaft between the two ball bearings, on which the ball bearing adjacent to the impeller is mounted, can have a bending problem due to an unbalanced load of the impeller.

In some cases, where the diameter of the rotating shaft is too small, an allowable limit speed of the rotating shaft may be lowered, the operating speed of the fan motor may be limited. In some cases, in order for the rotating shaft to withstand high-speed rotation, the larger the diameter of the rotating shaft is, the larger the diameter of the ball bearing is. In some cases, the life of the ball bearing may be shortened.

In some cases, an electric machine may include a rotor assembly. The rotor assembly includes a first ball bearing and a second ball bearing mounted on both sides of a rotating shaft with a rotor core permanent magnet therebetween. An O-ring may be provided on an outer circumferential surface of the ball bearings to extend the life of the ball bearings.

In some cases, where the two ball bearings are applied to a fan motor, it may be difficult or limited to reduce the size and weight of the fan motor. In some cases, a motor can include a bearing that supports the self-weight of the rotating shaft and a load applied to the rotating shaft while fixing the rotating shaft at a predetermined position.

In some cases, where a motor is applied to a vacuum cleaner, dust in an air current generated in the driving environment can penetrate into an operating region of the bearing to damage the bearings. The damage of the bearing may lead to a decrease in reliability for the operation of the motor. In some cases, where the motor includes a ball bearing or roller bearing, the motor may include a shield that blocks dust from the external environment by shielding an inner space in which the ball or roller is accommodated.

In some cases, an air bearing may have a more advantageous aspect to the rotating shaft of a motor rotating at a high speed, and thus various attempts have been made to apply it to the rotating shaft of an ultra-high speed motor used in a vacuum cleaner. For instance, the air bearing may have a structure in which the operating region of the bearing is open to allow air to enter and leave through a gap formed between the rotating shaft and the bearing for the operation of the bearing. The air bearing may support the rotating shaft by air flowing through the gap formed between the rotating shaft and the bearing.

In some cases, the air bearing may not have a shield structure for sealing the operating region due to the characteristics of the operating mechanism of the bearing as described above, and thus it may be difficult to block foreign substances such as dust from entering the operating region of the bearing.

### SUMMARY

The present disclosure describes a fan motor capable of downsizing and weight reduction as well as rotating at a high speed of 100,000 rpm or more.

The present disclosure also describes a fan motor that can extend the life of a bearing even when the diameter of a rotating shaft is increased.

The present disclosure further describes a fan motor that can provide an increased allowable limit speed for a high-speed rotation and that can help to prevent or reduce the bending of a rotating shaft.

The present disclosure further describes a fan motor that can maintain a constant air gap between a bearing and a rotating shaft to aligning the rotating shaft.

The present disclosure further describes a fan motor that can effectively block foreign substances such as dust from entering through a gap formed between a bearing supporting a rotating shaft and the rotating shaft using air flowing around the rotating shaft.

The present disclosure further describes a fan motor that can provide improved structural stability and durability and that can block foreign substances such as dust from entering through a gap formed between a bearing using air flowing around a rotating shaft and the rotating shaft.

According to one aspect of the subject matter, a fan motor includes a shroud that defines a suction port at an upstream end portion of the shroud and a first discharge port at a downstream end portion of the shroud, where the shroud is configured to guide air along a flow direction from the upstream end portion to the downstream end portion. The fan motor further includes a rotating shaft rotatably disposed inside the shroud, where the rotating shaft includes a first support portion and a second support portion that are spaced apart from each other in an axial direction of the rotating shaft, and a permanent magnet mounting portion disposed between the first support portion and the second support portion. The fan motor further includes an impeller disposed at a first end portion of the rotating shaft, an air bearing that is disposed adjacent to the impeller and configured to rotatably support the first support portion and that defines an air gap facing the first support portion, a permanent magnet disposed at the permanent magnet mounting portion between the first end portion and a second end portion of the rotating shaft opposite to the first end portion in the axial direction, and a ball bearing disposed at the second end portion of the rotating shaft and configured to rotatably support the second support portion.

Implementations according to this aspect can include one or more of the following features. For example, the air bearing can include a polyaryletherketone (PAEK) material or a polyetheretherketone (PEEK) material. In some examples, the air bearing can define an O-ring mounting groove on an outer circumferential surface of the air bearing along a circumferential direction, and the fan motor can further include an O-ring disposed in the O-ring mounting groove. In some examples, the air bearing defines a plurality of O-ring mounting grooves that are spaced apart from one another in the axial direction, and the fan motor can further include a plurality of O-rings disposed in the O-ring mounting grooves, respectively. In some implementations, an inner diameter of the air bearing is greater than a length of the air bearing in the axial direction.

In some implementations, the fan motor includes a stator core that surrounds the permanent magnet, where an inner diameter of the air bearing is less than an inner diameter of the stator core. In some implementations, a diameter of the first support portion is greater than a diameter of the second support portion. In some implementations, a diameter of the first support portion is greater than a diameter of the permanent magnet mounting portion.

In some implementations, the fan motor can include an O-ring holder that surrounds the ball bearing and that defines a plurality of O-ring mounting grooves on an outer wall of the O-ring holder, and a plurality of O-rings disposed in the plurality of O-ring mounting grooves, respectively. In some implementations, the impeller can include a hub that overlaps with the air bearing in the axial direction and covers the air bearing, and a plurality of blades that protrude from an outer circumferential surface of the hub.

In some implementations, the fan motor can include a stator including a stator core that surrounds the permanent magnet and is spaced apart from the permanent magnet, and a stator coil wound around the stator core. The fan motor can include a first bearing receiving portion that is defined between the impeller and the stator and accommodates the air bearing, a motor housing that surrounds the stator core and is disposed downstream relative to the first bearing receiving portion in the flow direction, a vane hub that is disposed inside the shroud and has a first side that surrounds the first bearing receiving portion, and a second side that surrounds the motor housing, a plurality of vanes that protrude from an outer circumferential surface of the vane hub and are coupled to an inner circumferential surface of the shroud, and a second bearing receiving portion that is defined inside the motor housing and accommodates the ball bearing.

In some implementations, the fan motor can include an outer passage that is defined between the shroud and the vane hub, that has an annular shape, and that is configured to transfer a part of air suctioned by the impeller from the suction port to the first discharge port, and an inner passage that is disposed inside the vane hub and the motor housing. The vane hub can define a plurality of communication holes that are in fluid communication with the outer passage and the inner passage and that are configured to receive another part of the air suctioned by the impeller from an upstream side of the outer passage into the inner passage.

In some implementations, the fan motor can include a plurality of first bridges that extend from an upper end of the motor housing to the first bearing receiving portion and that connect the first bearing receiving portion and the motor housing to each other, and a plurality of second bridges that extend in a radial direction away from an outer circumferential surface of the second bearing receiving portion toward an inner circumferential surface of the motor housing, where the plurality of second bridges connect the motor housing and the second bearing receiving portion to each other. The motor housing can define a plurality of second discharge ports that are in fluid communication with the inner passage and configured to discharge air guided along the inner passage, where one of the plurality of second discharge ports is positioned between two of the plurality of second bridges.

In some implementations, the plurality of second bridges can define a plurality of fastening grooves, respectively. The motor housing can define a plurality of fastening holes, each of which overlaps with one of the plurality of fastening grooves in a radial direction. The motor housing and the plurality of second bridges can be coupled to each other by a plurality of fastening members that are fastened to the plurality of fastening grooves through the plurality of fastening holes, respectively.

In some implementations, the fan motor can include a plurality of fastening portions that protrude in a radial direction away from an outer circumferential surface of the motor housing toward an inner circumferential surface of the shroud. The plurality of fastening portions can couple the shroud and the motor housing to each other, and the motor housing and the shroud can define a plurality of first discharge ports between the plurality of fastening portions. In some examples, the plurality of fastening portions and the plurality of second bridges can be alternately arranged and spaced apart from each other in a circumferential direction of the motor housing such that each of the plurality of fastening portions and each of the plurality of second bridges do not to overlap with each other in a radial direction of the motor housing.

In some implementations, the fan motor can include a first O-ring holder that is disposed at an outer circumferential surface of the air bearing, that surrounds the air bearing, and that defines a plurality of first O-ring mounting grooves, and a plurality of first O-rings disposed in the plurality of first O-ring mounting grooves, respectively. The fan motor can further include a second O-ring holder that is disposed at an outer circumferential surface of the ball bearing, the surrounds the ball bearing, and that defines a plurality of second O-ring mounting grooves, and a plurality of second O-rings disposed in the plurality of second O-ring mounting grooves, respectively.

In some implementations, the air bearing can include a sealing portion that surrounds a part of the rotating shaft, where the sealing portion has a first surface that faces the rotating shaft and that is spaced apart from the rotating shaft to thereby define a gap at a predetermined distance from the rotating shaft. The gap can be configured to allow flow of air therethrough, and the sealing portion can be arranged adjacent to the air bearing in the axial direction and extends along a circumference of the rotating shaft. The sealing portion can be configured to block part of the air passing through the gap.

In some implementations, the fan motor can include a housing portion having an inner space that accommodates the air bearing therein, where the sealing portion extends in a radial direction from the housing portion toward the rotating shaft. The sealing portion can have a first side fixed to the housing portion, and a second side spaced apart from the rotating shaft to thereby define a flow path of air at a preset distance from the rotating shaft. In some implementations, the sealing portion can be disposed vertically above or below the air bearing in the axial direction.

In some implementations, the sealing portion can be provided in plural, and can include a first sealing member and a second sealing member, wherein the first sealing member is disposed closer to the air bearing than to the second sealing member on a length direction of the rotating shaft. A first sealing gap formed between the rotating shaft and the other side of the first sealing member facing the rotating shaft, and a second sealing gap formed between the rotating shaft and the other side of the second sealing member facing the rotating shaft can be different from each other.

In some implementations, the first sealing gap can be formed to be wider than the second sealing gap. The sealing portion can be provided in plural, and can include an upper sealing member and a lower sealing member, wherein the upper sealing member is provided at the upper side of the air bearing on a length direction of the rotating shaft, and the lower sealing member is provided at a lower side of the air bearing in a length of the rotating shaft.

In some implementations, the housing portion can have a groove portion defined to be recessed on one surface facing the rotating shaft to fix one side of the sealing portion in an accommodating state. In some examples, the groove portion can be disposed to be inclined toward an outer region of the gap on a length direction of the rotating shaft, and one side of the sealing portion can be accommodated in the groove portion, and can extend to be inclined toward the outer region of the gap in a length direction of the rotating shaft.

In some implementations, the sealing portion can include a first portion constituting part of the sealing portion and made of a first material; and a second portion constituting another part of the sealing portion and made of a second material. The first portion can be disposed to surround at least part of the second portion, and the second material can be formed to have a greater rigidity than the first material.

In some implementations, the sealing portion can include a first portion constituting one side of the sealing portion, part of which is accommodated in the groove portion, and made of a first material, and a second portion constituting the other side of the sealing portion and made of a second material different from the first material. In some examples, a first gap formed between the other side of the sealing portion and the rotating shaft can be formed to be narrower than a second gap formed between the rotating shaft and one surface of the air bearing facing the rotating shaft.

In some implementations, the fan motor can further include a housing portion provided with an inner space accommodating the air bearing therein, where the sealing portion is provided with a slit, one side of which is fixed to the housing portion, and the other side of which is fixed to the rotating shaft, and disposed to pass through a direction perpendicular to one surface facing the air bearing to form part of the movement path, and the air entering and leaving the gap is blocked by the sealing portion excluding the slit. In some examples, the sealing portion can be disposed to have a C-shape. The slit can have a hole shape. The sealing portion can further include a mesh portion provided on the slit to partition the movement path into a plurality of regions.

In some implementations, the sealing portion can be disposed such that one side thereof is fixed to the rotating shaft, and the other side thereof extends in a direction away from the rotating shaft to form part of the movement path. In some examples, the sealing portion can be made of the same type of material as the rotating shaft. The sealing portion can include a curved portion provided on the other side of the sealing portion forming part of the movement path to define a curved surface toward an outer region of the gap on a length direction of the rotating shaft. In some cases, the sealing portion can include at least one of polytetrafluoroethylene (PTFE) and rubber.

In some implementations, an air bearing can be applied as a first bearing that supports a first support portion of a rotating shaft located adjacent to an impeller. The air bearing can be lubricated with air with no additional working fluid, and thus friction between the air bearing and the rotating shaft may not occur. In some examples, when the rotating shaft rotates at a high speed above 100,000 rpm, wear due to friction between the air bearing and the rotating shaft may not occur, thereby extending the life of the bearing. Furthermore, the air bearing can be applied to extend the life of the fan motor during high-speed rotation.

In some implementations, the air bearing can have an advantage of extending the life even when the diameter is increased. Accordingly, a diameter of the air bearing can be increased to increase an axial diameter of a first support portion. In addition, a diameter (thickness) of the first support portion of the rotating shaft adjacent to the impeller can be increased (thickened) to prevent bending of the rotating shaft due to uneven load of the impeller during high-speed rotation. Furthermore, a thickness of the first support portion can be increased to increase an allowable limit speed of the rotating shaft.

For example, a diameter of the first support portion can be disposed to be larger than that of an impeller coupling portion of the rotating shaft to which the impeller is coupled. In some examples, a diameter of the first support portion can be disposed to be larger than that of a permanent magnet mounting portion of the rotating shaft on which a permanent magnet is mounted. In some examples, a diameter of the first support portion can be disposed to be larger than that of a second support portion supported by a second bearing.

In some implementations, the rotating shaft can be assembled such that a stator is pre-assembled to an inner side of a shroud and then disposed on the same center line of first and second receiving portions of the shroud through a rotor receiving hole disposed inside a stator core. In order for the first support portion to be coupled to an inner circumferential surface of the first bearing through the rotor receiving hole, a diameter of the first support portion can be disposed to be smaller than an inner diameter of the stator core. In some examples, an inner diameter of the first bearing can be disposed to be smaller than that of the stator core to secure the assemblability of the rotating shaft or the like. For example, while a ball bearing is coupled to a second support portion, the first support portion of the rotating shaft can be allowed to be assembled to an inner side of the air bearing.

In some examples, the air bearing may not be disposed in a suction passage, an expansion passage, and a cooling passage, which are the main passages of the fan motor, and the impeller can be disposed to cover the first bearing receiving portion in which the air bearing is accommodated, thereby blocking foreign substances such as dust from entering the air bearing.

In some examples, first O-ring mounting grooves can be disposed on an outer wall of a first O-ring holder surrounding the air bearing, and a plurality of first O-rings can be mounted in the plurality of first O-ring mounting grooves, thereby allowing the rotating shaft to be aligned in an axial direction on the center line of the shroud.

In some examples, the first O-ring can be made of an elastic material, thereby attenuating shock transmitted from the outside to the first bearing.

In some examples, a ball bearing can be applied as a second bearing supporting the second support portion of the rotating shaft positioned at an opposite side of the impeller with respect to the permanent magnet mounting portion. Since the second support portion of the rotating shaft positioned at an opposite side of the impeller is less affected from uneven load of the impeller, a shaft diameter of the second support portion can be smaller than that of the first support portion.

For this reason, the ball bearing can be applied to the second support portion. The ball bearing is cheaper than the air bearing. Therefore, it is more advantageous in terms of cost to apply one air bearing and one ball bearing than to apply two air bearings for bearings supporting both sides of the rotating shaft.

In some examples, when using two bearings with only air bearings, a thrust bearing, which is an essential element, should be used. However, when one air bearing and one ball bearing are applied, the use of the thrust bearing can be eliminated, thereby greatly contributing to the downsizing and weight reduction of the fan motor.

In some examples, a first vane hub and a second vane hub can be disposed on a straight line with each other at a downstream side of the impeller with respect to a flow direction of air generated by the impeller, and a cooling passage disposed between the shroud and the first and second vane hubs can be disposed in a straight line without bending, thereby minimizing the flow resistance of air and increasing the cooling efficiency of the motor with air.

In some examples, a plurality of second vanes can be disposed an outer circumferential surface of the second vane hub to protrude into the cooling passage, and the plurality of second vanes not only guide the flow of air, but also expand a heat exchange area between the air and the stator, thereby maximizing the cooling performance of the motor.

In some examples, a plurality of first fastening portions can protrude downward in an axial direction in a first bearing housing. A plurality of second fastening portions can protrude upward in an axial direction in the second vane hub. A first fastening portion and a second fastening portion can be disposed to overlap in a radial direction with the first vane hub therebetween. A fastening member such as a screw can be fastened through the first fastening portion of the first bearing housing, the first vane hub, and the second fastening portion of the second bearing housing to firmly fasten the first bearing housing, the first vane hub, and the second vane hub disposed along an axial direction to each other, thereby greatly contributing to the downsizing and weight reduction of the motor with a simple and compact fastening structure.

In some examples, a plurality of vanes protruding from an outer circumferential surface of the vane hub can be forcibly fitted and coupled to an inner circumferential surface of the shroud, thereby firmly fastening the shroud and the vane hub to each other. The first bearing receiving portion and the motor housing can be integrally connected by a plurality of first bridges. The vane hub and the motor housing can be disposed to overlap in a radial direction and bonded to each other by an adhesive, thereby firmly fastening to each other.

In some examples, a plurality of fastening portions can protrude radially outward from an outer circumferential surface of the motor housing, and the plurality of fastening portions can be fastened to fastening members such as screws on an inner circumferential surface of the shroud, thereby allowing the shroud and the motor housing to be firmly coupled to each other.

The second bearing receiving portion and the motor housing can be connected to each other by a plurality of second bridges, and the motor housing and the second bridges can be connected to each other by fastening members such as screws, thereby greatly contributing to the downsizing and weight reduction of the motor with a simple and compact fastening structure.

In some examples, a fastening position between the shroud and a fastening portion of the motor housing and a fastening position between the motor housing and the second bridge of the second bearing receiving portion can be disposed to be spaced apart in a circumferential direction to have different phase angles, thereby securing the downsizing and assemblability of the motor in spite of a small assembly space.

In some examples, the fan motor can include an air bearing one surface of which, facing the rotation shaft, is spaced apart from the rotation shaft at a predetermined distance to form a gap through which air flows, and a sealing portion disposed to block part of air flowing toward the gap formed between the air bearing and the rotation shaft along a circumference of the rotating shaft while forming part of a movement path of air entering and leaving the gap between the air bearing and the rotation shaft.

In some implementations, the air entering and leaving the gap can efficiently move through a region that is not blocked by the sealing portion, thereby stably providing the operation of the air bearing. In addition, part of the air to flow into the gap can be formed to be blocked by the sealing portion, thereby greatly reducing the probability of foreign substances such as dust moving along with the flow of air to flow into the gap between the air bearing and the rotating shaft. As a result, it can be possible to prevent damage due to dust flowing into the operating region of the bearing using air flowing around the rotating shaft as well as greatly improving the operational reliability of the fan motor.

In some examples, one side of the sealing portion can be fixed while being partially accommodated in a groove portion disposed to be recessed in one surface of the housing portion facing the rotating shaft, thereby further securing the structural stability of the sealing portion. Furthermore, the sealing portion can be composed of a first portion and a second portion each made of different first and second materials, and the first portion can be disposed to surround the second portion. Here, the second material constituting the second portion surrounded by the first portion can be configured to have greater rigidity than the first material, thereby more improving the durability of the sealing portion.

### BRIEF DESCRIPTION OF THE DRAWINGS

FIG. 1 is a perspective view showing an example of a fan motor.

FIG. 2 is an exploded view showing the fan motor in FIG. 1.

FIG. 3 is a cross-sectional view taken along line III-III in FIG. 1.

FIG. 4 is a conceptual diagram showing examples of a first bearing housing, a first vane hub, and a second vane hub that are coupled to one another in the fan motor in FIG. 3.

FIG. 5 is a perspective view showing an example of a first O-ring holder mounted to surround an outer surface of an air bearing in FIG. 3.

FIG. 6 is an enlarged cross-sectional view of portion VI in FIG. 3, and shows the air bearing mounted to an inner side of an O-ring holder.

FIG. 7 is a perspective view showing an example of a fan motor.

FIG. 8 is an exploded view showing the fan motor in FIG. 7.

FIG. 9 is a cross-sectional view taken along line IX-IX in FIG. 7.

FIG. 10 is a perspective view showing an air bearing in FIG. 9.

FIG. 11 is a cross-sectional view taken along line XI-XI in FIG. 10, showing an example of a first O-ring mounted on an outer circumferential surface of the air bearing.

FIG. 12 is a perspective view showing an example of a first O-ring mounting groove on the air bearing.

FIG. 13 is a cross-sectional view taken along line XIII-XIII of FIG. 12, showing an example of a plurality of first O-rings mounted on the air bearing.

FIG. 14 is an exploded perspective view showing an example of a fan motor.

FIG. 15 is a perspective view showing an example of a bearing portion and a holder portion illustrated in FIG. 14.

FIG. 16 is a perspective view showing a sealing portion illustrated in FIG. 14.

FIGS. 17 to 22B are views showing examples of the sealing portion shown in FIG. 16.

FIG. 23 is a cross-sectional view showing the fan motor illustrated in FIG. 14 in an assembled state.

FIG. 24 is an enlarged view showing an example of a motor assembly disposed around a bearing portion illustrated in FIG. 23.

FIG. 25 is a view showing an example of an inner space of a housing portion except for the bearing portion and a snap ring illustrated in FIG. 24.

FIG. 26 is a conceptual view showing an example of the fan motor enlarged around the bearing portion illustrated in FIG. 24.

FIGS. 27 through 34 are conceptual views showing examples of the fan motor illustrated in FIG. 26.

### DETAILED DESCRIPTION

Hereinafter, one or more implementations disclosed herein will be described in detail with reference to the accompanying drawings, and the same or similar elements are designated with the same numeral references regardless of the numerals in the drawings and redundant description thereof will be omitted.

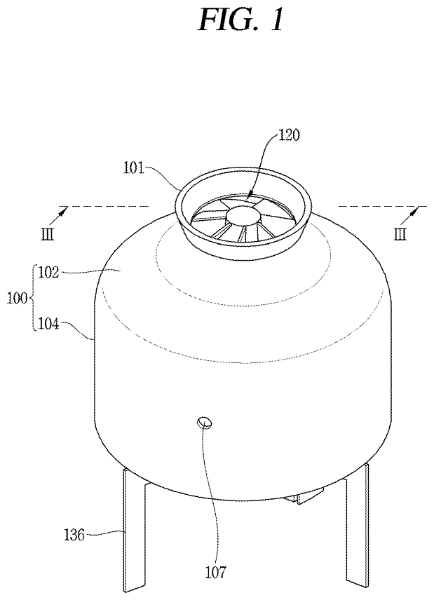

FIG. 1 is a perspective view showing an example of a fan motor.

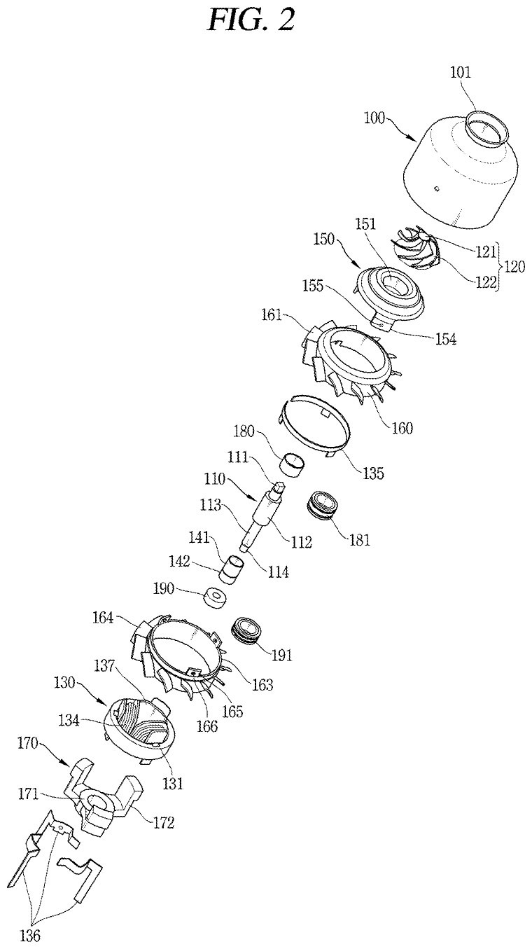

FIG. 2 is an exploded view of the fan motor in FIG. 1.

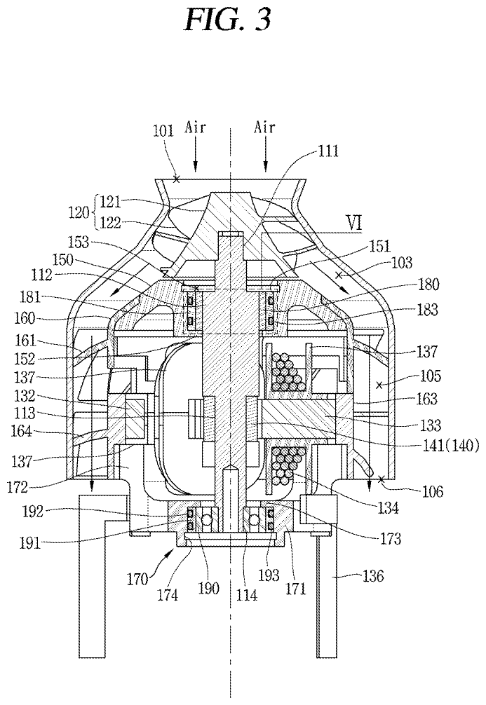

FIG. 3 is a cross-sectional view taken along line III-III in FIG. 1.

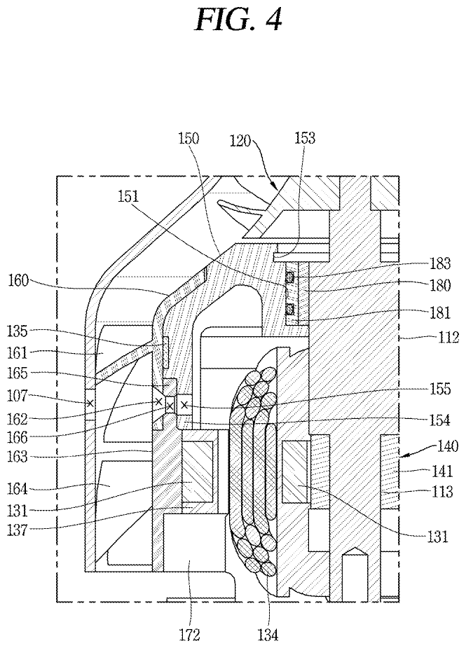

FIG. 4 is a conceptual diagram showing a configuration in which a first bearing housing 150, a first vane hub 160, and a second vane hub 163 are coupled to one another in FIG. 3.

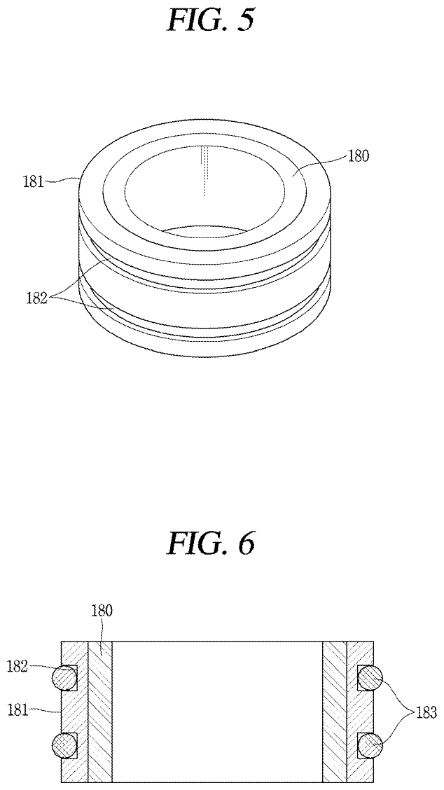

FIG. 5 is a perspective view showing a configuration in which a first O-ring holder 181 is mounted to surround an outer surface of an air bearing 180 in FIG. 3.

FIG. 6 is an enlarged view of portion VI in FIG. 3, which is a cross-sectional view showing a configuration in which the air bearing 180 is mounted to an inner side of an O-ring holder.

The fan motor can include a shroud 100, a rotating shaft 110, an impeller 120, a first bearing housing 150, a first vane hub 160, a second vane hub 163, and a second bearing housing 170, a stator 130, a rotor 140, an air bearing 180, and a ball bearing 190.

The shroud 100 defined an appearance of the fan motor. The shroud 100 has a circular cross-sectional shape.

The shroud 100 has a receiving space therein.

The shroud 100 can be divided into a suction port 101, a first receiving portion 102, a second receiving portion 104, and a discharge port 106 along a length direction (top-down or axial direction).

The suction port 101 and the first receiving portion 102 can be defined in a conical shape. The second receiving portion 104 can be defined in a cylindrical shape.

The suction port 101 is disposed at an upper end portion of the shroud 100. External air can be suctioned into the shroud 100 through the suction port 101.

A bottle neck portion having a narrow cross-sectional area can be formed at a downstream side of the suction port 101 with respect to a flow direction of air. The flow speed of air in the bottle neck portion can be increased to increase the suction speed.

The first receiving portion 102 is disposed at a downstream side of the suction port 101 with respect to the flow direction of the air.

The second receiving portion 104 is disposed at a downstream side of the first receiving portion 102 with respect to the flow direction of the air.

The impeller 120 and the first bearing housing 150 can be accommodated in the first receiving portion 102.

The first receiving portion 102 can be defined such that the cross-sectional area gradually increases from the bottleneck portion to the second receiving portion 104. An outer circumferential surface of the first receiving portion 102 can be disposed to be inclined toward the second receiving portion 104 from the bottleneck portion.

The second receiving portion 104 can be disposed at a downstream side of the first receiving portion 102.

The second receiving portion 104 can be defined in a cylindrical shape having a diameter larger than that of the suction port 101.

The first vane hub 160 and the second vane hub 163 can be accommodated in the second receiving portion 104.

The stator 130 can be accommodated inside the second vane hub 163.

The second bearing housing 170 can be accommodated inside the second vane hub 163.

The discharge port 106 is disposed at a lower end of the second receiving portion 104. The discharge port 106 is configured to discharge air inside the second receiving portion 104 to the outside.

The rotating shaft 110 is disposed along the center line of the shroud 100 crossing the center of the shroud 100 in an axial direction.

The impeller 120 is configured to suction external air.

The impeller 120 includes a hub 121 and a plurality of blades 122.

The hub 121 is located at a center portion of the impeller 120. The hub 121 can be defined in a conical shape defined to increase in diameter from the upper end to the lower end.

The plurality of blades 122 can be disposed to protrude in a spiral shape on an outer circumferential surface of the hub 121. The plurality of blades 122 can be disposed to be spaced apart in a circumferential direction of the hub 121.

The plurality of blades 122 can be defined to increase in distance therebetween from the upper end to the lower end of the hub 121.

The plurality of blades 122 can be spaced apart from the first receiving portion 102 at a distance.

A suction passage can be disposed between the first receiving portion 102 and the hub 121.

An impeller coupling portion 111 can be disposed at one end portion of the rotating shaft 110. The impeller 120 is coupled to one end portion of the rotating shaft 110 to rotate together with the rotating shaft 110.

As the impeller 120 rotates, external air can flow in through the suction port 101 along the suction passage of the shroud 100.

The rotating shaft 110 can include a first support portion 112, a permanent magnet mounting portion 113, and a second support portion 114 defined with different diameters along an axial direction from the upper end to the lower end.

The first support portion 112 has the largest diameter. The first support portion 112 is located adjacent to the impeller coupling portion 111.

A first bearing is coupled to the first support portion 112. The first bearing can be implemented as an air bearing 180.

The first bearing is configured to rotatably support the first support portion 112 of the rotating shaft 110.

The permanent magnet mounting portion 113 is located between the first support portion 112 and the second support portion 114.

The permanent magnet mounting portion 113 can have a smaller diameter than the first support portion 112.

A permanent magnet 141 of the rotor 140 is mounted on the permanent magnet mounting portion 113 so as to surround an outer circumferential surface of the permanent magnet mounting portion 113.

A diameter of the second support portion 114 is smaller than that of the permanent magnet mounting portion 113.

A second bearing is coupled to the second support portion 114. The second bearing can be implemented as a ball bearing 190.

The second bearing is disposed to rotatably support the second support portion 114 of the rotating shaft 110.

The first support portion 112 and the second support portion 114 can be disposed at upper and lower portions of the rotating shaft 110 with the permanent magnet mounting portion 113 therebetween. The second support portion 114 can be located at an opposite side of the impeller coupling portion 111 in an axial direction.

The first bearing housing 150 is disposed at a downstream side of the impeller 120 to be spaced apart at a predetermined distance.

The first bearing housing 150 can be defined in a combination of a conical shape and a cylindrical shape.

An upstream side of the first bearing housing 150 can be defined in a conical shape, and a downstream side of the first bearing housing 150 can be defined in a cylindrical shape.

A first bearing receiving portion 151 is disposed to be recessed at the center portion of the first bearing housing 150.

The first bearing receiving portion 151 can be disposed to be open toward the impeller 120.

The first bearing receiving portion 151 can be disposed to pass therethrough in an axial direction.

The first bearing receiving portion 151 can have a diameter larger than that of the first support portion 112 and the first bearing.

The first bearing receiving portion 151 can be defined in a cylindrical shape. The first bearing can be accommodated in the first bearing receiving portion 151.

A first axial movement limiting portion 152 can extend from a lower end of the first bearing receiving portion 151 to a radially inner side thereof.

A through hole can be disposed inside the first axial movement limiting portion 152. A diameter of the through hole can be disposed to be larger than that of the first support portion 112 and smaller than that of the first bearing.

According to this configuration, the first axial movement limiting portion 152 can limit movement in an axial direction toward the rotor 140 while the first bearing is accommodated in the first bearing receiving portion 151.

A first snap ring receiving groove 153 can be disposed radially outward from an upper end of the first bearing receiving portion 151.

The first snap ring receiving groove 153 is mounted to accommodate a snap ring therein. The snap ring can be defined in a “C” shape. The snap ring is defined in a ring shape with one side open to be elastically deformable such that an open area inside the snap ring expands or contracts in a radial direction.

The snap ring can help to prevent the first bearing from being axially separated from the first bearing receiving portion 151 toward the impeller 120 while being accommodated in the first snap ring receiving groove 153.

The impeller 120 is disposed to overlap with the first bearing housing 150 in an axial direction to cover the first bearing receiving portion 151.

The first bearing housing 150 can be defined in a conical shape such that the diameter gradually increases from an upstream side to a downstream side with respect to a flow direction of air.

A ratio of increasing the diameter from the top to the bottom of the first bearing housing 150 in the axial direction is greater than that of increasing the diameter from the upper end to the lower end of the hub 121.

An inclination of an outer surface of the hub 121 is steeper than that of an outer surface of the first bearing housing 150.

An upper end of the first bearing housing 150 is slightly larger in diameter than a lower end of the hub 121, but is defined to be large at a rate similar to a diameter increase rate of the first bearing housing 150

According to this configuration, it is possible to minimize a flow resistance of air.

An expansion passage 103 can be disposed between the first receiving portion 102 and the first bearing housing 150. The expansion passage 103 is a passage for transferring air suctioned from the suction passage to first vanes 161 which will be described later. The expansion passage 103 can be disposed such that a diameter of the passage increases from the impeller 120 to the first vanes 161.

The first vane hub 160 is configured to surround part of an outer surface of the first bearing housing 150.

An upper portion of the first vane hub 160 can surround the first bearing housing 150, and a lower portion of the first vane hub 160 can be defined in a cylindrical shape having a constant diameter in an axial direction.

The connection ring 135 can be mounted on a lower inner circumferential surface of the first vane hub 160. The lower portion of the first vane hub 160 is disposed to surround the circular connection ring 135. The connection ring 135 is configured to connect an end (neutral line) of a three-phase stator coil 134.

A surrounding groove can be concavely disposed on an outer surface of the first bearing housing 150 at a depth equal to a thickness of the first vane hub 160. Accordingly, the first vane hub 160 is inserted into the surrounding groove, and thus a step difference between the first bearing housing 150 and the first vane hub 160 may not occur.

The first vane hub 160 and the first bearing housing 150 can be joined by a surrounding groove.

A plurality of first vanes 161 can be disposed on an outer circumferential surface of the first vane hub 160 to protrude along a spiral direction.

The plurality of first vanes 161 are disposed to be spaced apart in a circumferential direction of the first vane hub 160.

The first vane hub 160 and the first vanes 161 can be integrally formed of an insulating plastic material. The first vanes 161 are configured to guide air flowing in through the expansion passage 103 to the second vanes 164.

The plurality of first vanes 161 can be coupled to an inside of the second receiving portion 104 of the shroud 100 in a forcibly fitting manner.

The second vane hub 163 is disposed at a downstream side of the first vane hub 160.

The second vane hub 163 can be defined in a cylindrical shape.

The second vane hub 163 is configured to surround the stator 130.

The stator 130 can be mounted to be accommodated inside the second vane hub 163.

The stator 130 can be adhered to upper inner circumferential surface of the second vane hub 163 by an adhesive element such as an adhesive.

The stator 130 includes a stator core 131 and a stator coil 134.

The stator core 131 can include a back yoke 132 and a plurality of teeth 133.

The back yoke 132 can be defined in a ring shape. Each of the plurality of teeth 133 is disposed to protrude from an inner surface of the back yoke 132 toward the center of the back yoke 132.

The plurality of teeth 133 can be disposed to be detachable from the back yoke 132. In some examples, the plurality of teeth 133 can have three teeth.

A coupling protrusion can be disposed to protrude from one end portion of each of the plurality of teeth 133.

The coupling protrusion can be slidably coupled in an axial direction along a coupling groove disposed at an inner side of the back yoke 132.

A pole shoe can be disposed to protrude in a circumferential direction at the other end portion of each of the plurality of teeth 133. The plurality of teeth 133 are disposed to be spaced apart in a circumferential direction of the back yoke 132.

The stator coil 134 can be configured as a three-phase coil. The plurality of stator coils 134 can be wound around the teeth 133 for each phase in the form of a concentrated winding.

In some implementations, the fan motor can improve the output of the motor, and enable the downsizing and weight reduction of the motor.

An insulator 137 insulating between the stator core 131 and the stator coil 134 can be interposed between the stator core 131 and the stator coil 134. The insulator 137 can include a teeth insulator 137 disposed to surround part of the teeth 133 and a back yoke insulator 137 disposed to cover part of the back yoke 132. The insulator 137 is formed of an insulating material such as plastic.

The rotor 140 includes a permanent magnet 141.

The permanent magnet 141 can be mounted on an outer circumferential surface of the permanent magnet mounting portion 113.

The permanent magnet mounting portion 113 extends in an axial direction from the first support portion 112. The permanent magnet mounting portion 113 can be disposed to have a smaller diameter than the first support portion 112.

The permanent magnet 141 can be disposed to have a diameter smaller than an inner diameter of the stator core 131.

The inner diameter of the stator core 131 denotes a diameter of circumference passing through inner ends of the plurality of pole shoes in a circumferential direction.

The permanent magnet 141 and the first support portion 112 can be disposed to have the same diameter.

The permanent magnet 141 can be rotatably mounted on the permanent magnet mounting portion 113 of the rotating shaft 110 with an air gap radially inward with respect to the pole shoes of the stator core 131.

In order to limit the movement of the permanent magnet 141 in an axial direction, an end cap 142 can be provided at a downstream side of the permanent magnet mounting portion 113. The end cap 142 can be defined in a cylindrical shape having the same diameter as the permanent magnet 141.

One side of the permanent magnet 141 can be brought into contact with the first support portion 112 having a diameter larger than that of the permanent magnet mounting portion 113, thereby limiting upstream movement in an axial direction.

Downstream movement in an axial direction at the other side of the permanent magnet 141 can be limited by the end cap 142.

When three-phase alternating current is applied to each of a plurality of stator coils 134, the permanent magnet 141 can electromagnetically interact with a magnetic field generated around the stator coil 134 to generate a rotational force.

According to this configuration, the rotating shaft 110 can rotate due to electromagnetic interaction between the rotor 140 and the stator 130.

A plurality of second vanes 164 can be disposed to protrude along a spiral direction on an outer circumferential surface of the second vane hub 163.

The plurality of second vanes 164 are disposed to be spaced apart in a circumferential direction of the second vane hub 163.

The plurality of second vanes 164 are configured to guide air that has passed through the first vanes 161 to the discharge port 106.

The plurality of first vanes 161 and the plurality of second vanes 164 are disposed to be spaced apart on a straight line in an axial direction.

A cooling passage 105 can be disposed between the second receiving portion 104 and the first vane hub 160.

The cooling passage 105 can be disposed between the second receiving portion 104 and the second vane hub 163.

The cooling passage 105 can be defined in a straight line shape along an axial direction to minimize flow resistance.

The cooling passage 105 is configured to cool the motor using air moving from the expansion passage.

The plurality of second vanes 164 are disposed to be accommodated in the cooling passage 105.

The plurality of second vanes 164 can be integrally formed with the second vane hub 163. The plurality of second vanes 164 can be formed of a metal material of the same material as that of the second vane hub 163. The second vane hub 163 and the second vanes 164 can be formed of aluminum or an aluminum alloy material having excellent thermal conductivity.

The plurality of second vanes 164 not only serve to guide air, but also serve as radiating fins for dissipating the heat of the motor received through the second vane hub 163 to the cooling passage 105.

The second vane hub 163 can dissipate heat transferred from the stator 130 to the cooling passage 105 through heat conduction.

For example, when a current is applied to the stator coil 134, heat is generated from the stator coil 134. The heat generated from the stator coil 134 is heat conducted through the teeth 133 and the back yoke 132 of the stator core 131 and transferred to the second vane hub 163.

The plurality of second vanes 164 are configured to expand a heat exchange area with air.

Looking at the movement path of air, air is suctioned into the shroud 100 through the suction port 101, and discharged to the outside through the discharge port 106 while moving along the cooling passage 105 through the suction passage and the expansion passage 103.

The air flowing along the cooling passage 105 can exchange heat with the plurality of second vanes 164 and the second vane hub 163 to cool the heat of the stator 130.

The plurality of second vanes 164 are coupled to an inner surface of the second receiving portion 104 of the shroud 100 in a forcibly fitting manner.

The second bearing housing 170 is disposed under the second vane hub 163.

The second bearing housing 170 includes a second bearing receiving portion 171 at an inner central portion thereof.

The second bearing receiving portion 171 can be defined in a ring shape.

The second bearing is accommodated in the second bearing receiving portion 171.

The second bearing can be implemented as a ball bearing 190.

A second axial movement limiting portion 173 can extend radially inward from an upper end of the second bearing receiving portion 171.

A through hole can be disposed inside the second axial movement limiting portion 173. A diameter of the through hole can be disposed to be larger than that of the second support portion 114 and the permanent magnet mounting portion 113.

The second axial movement limiting portion 173 can protrude radially inward with an inner diameter smaller than an outer diameter of the second bearing. Accordingly, the second bearing can limit movement in an axial direction toward the permanent magnet mounting portion 113 while being accommodated in the second bearing receiving portion 171.

The second bearing receiving portion 171 can be disposed to be open downward.

A second snap ring receiving groove 174 can be disposed at a lower end of the second bearing receiving portion 171 to be concave radially outward.

A snap ring can be mounted to be accommodated in the second snap ring receiving groove 174.

The snap ring can help to prevent the second bearing from being separated from the second bearing receiving portion 171 to the outside while being accommodated in the second snap ring receiving groove 174.

The second bearing housing 170 can include a plurality of bridges 172.

The plurality of bridges 172 can be disposed to protrude upward from an upper side of the second bearing receiving portion 171 toward an inner circumferential surface of the second vane hub 163.

An upper end portion of each of the plurality of bridges 172 is brought into contact with a lower side of an inner circumferential surface of the second vane hub 163, and can be bonded to each other by an adhesive element such as an adhesive.

A plurality of bus bars 136 can be provided at a lower end portion of each of the plurality of bridges 172.

The plurality of bus bars 136 are respectively connected to the three-phase stator coil 134 to apply three-phase AC currents.

A fastening structure of the first vane hub 160, the first bearing housing 150, and the second vane hub 163 will be described with reference to FIG. 4.

The first vane hub 160, the first bearing housing 150 and the second vane hub 163 can be fastened to each other.

A plurality of first fastening holes 162 can be disposed on the first vane hub 160.

A plurality of first fastening portions 154 can be disposed to protrude downward at a lower end of the first bearing housing 150. The plurality of first fastening portions 154 can be disposed to be spaced apart in a circumferential direction of the first bearing housing 150.

A plurality of second fastening holes 155 can be disposed to pass through the plurality of first fastening portions 154 in a thickness direction.

A plurality of second fastening portions 165 can be disposed to protrude upward at an upper end of the second vane hub 163. The plurality of second fastening portions 165 can be disposed to be spaced apart in a circumferential direction of the second vane hub 163.

A plurality of third fastening holes 166 can be disposed to pass through the plurality of second fastening portions 165, respectively, in a thickness direction.

The plurality of first fastening portions 154 and the plurality of second fastening portions 165 can be arranged to overlap in a thickness direction of the first fastening portions 154 (a direction perpendicular to a radial or axial direction of the first vane hub 160).

The second fastening portions 165 can be disposed to overlap on an inner circumferential surface of the first vane hub 160 in a thickness direction.

The first fastening portions 154 can be disposed to overlap inside the second fastening portions 165.

The plurality of first fastening holes 162, the plurality of second fastening holes 155, and the plurality of third fastening holes 166 can be arranged to overlap in a thickness or radial direction of the first vane hub 160.

Fastening members such as screws can be coupled through the first fastening holes 162, the second fastening holes 155, and the third fastening holes 166 to fasten the first vane hub 160 and the second vane hub 163, and the first bearing housing 150 to one another.

A connection ring mounting groove can be disposed concave in a thickness direction at an upper side of an outer circumferential surface of the first fastening portions 154. The connection ring 135 can be inserted into the connection ring mounting groove. The connection ring 135 can be disposed between the first vane hub 160 and the first fastening portions 154 of the first bearing housing 150.

Fastening grooves can be disposed concave in a thickness direction at a lower side of an outer circumferential surface of the first fastening portions 154. The second fastening portions 165 can be inserted into the fastening grooves.

An upper thickness of the first fastening portions 154 can be defined to be equal to the sum of lower thicknesses of the second fastening portions 165 and the first fastening portions 154, respectively.

The second fastening portions 165 can be disposed to be smaller than a thickness of the second vane hub 163.

The first vane hub 160 can be disposed to surround the second fastening portions 165.

When mounted to surround the second fastening portions 165 of the first vane hub 160, the first vane hub 160 and the second vane hub 163 can be disposed to overlap in an axial direction with no step difference.

According to this configuration, the first fastening portions 154 of the first bearing housing 150, the first vane hub 160, and the second fastening portions 165 of the second vane hub 163 can be arranged to overlap radially from an inside to an outside thereof, and the fastening members can be fastened through the fastening holes disposed in the first fastening portions 154, the first vane hub 160, and the second fastening portions 165, and the first bearing housing 150, the first vane hub 160 and the second vane hub 163 can be made of a simple fastening structure while being firmly fastened to each other, and compactly disposed to contribute to downsizing and weight reduction.

A plurality of confirmation windows 107 can be disposed in a thickness direction at one side on a lateral surface of the shroud 100

The confirmation windows 107 can be disposed in a radial direction of the first fastening holes 162, the second fastening holes 155, and the third fastening holes 166 and the shroud 100.

The first fastening holes 162 to the third fastening holes 166 can be exposed through the confirmation windows 107.

The fastening members fastened to the first fastening holes 162 to the third fastening holes 166 can be exposed through the confirmation windows 107.

In some examples, where the rotating shaft 110 is not aligned with the center of the shroud 100 in an axial direction, the rotating shaft 110 can be aligned through the confirmation window 107.

For example, when one side of the rotating shaft 110 is twisted, a tool such as a driver can be passed through the confirmation window 107 to press or rotate one side of the first vane hub 160 to align it in an axial direction.

Referring to FIGS. 5 and 6, the first bearing supporting the first support portion 112 can be implemented as an air bearing 180.

The air bearing 180 can be defined in a hollow cylindrical shape. A shaft receiving portion is disposed inside the air bearing 180.

The air bearing 180 is disposed to form an air gap between an outer circumferential surface of the first support portion 112 and an inner circumferential surface of the air bearing 180.

The air gap can be 0.04 mm or less.

In order to secure the assemblability of the rotating shaft 110 and the rotor 140, an inner diameter of the air bearing 180 can be disposed to be smaller than that of the stator core 131.

An inner diameter (d) of the air bearing 180 can be disposed to be larger than a length (height) of the air bearing 180 in order to reduce wear of an inner diameter surface of the air bearing 180.

An inner diameter of the stator core 131 denotes a diameter of a circle passing through inner end portions of the plurality of teeth 133 in a circumferential direction.

A ratio of a length (L) of the air bearing 180 to the inner diameter (d) of the air bearing 180 can be 0.7 or less. When the length/inner diameter ratio of the air bearing 180 exceeds 0.7, an amount of wear on an inner diameter surface of the air bearing 180 can be greatly increased.

Since the air bearing 180 rotatably supports the rotating shaft 110 in a non-lubricating state, a material having a low coefficient of friction and excellent wear resistance is used.

For example, the air bearing 180 can be made of a polyetheretherketone (PEEK) or polyaryletherketone (PAEK) material having excellent non-lubricating friction characteristics and wear resistance.

PEEK or PAEK has low wear on the bearing after operation and small change in gap with the shaft.

The air bearing 180 can form an air layer between the rotating shaft 110 and an inner circumferential surface of the air bearing 180 with no additional working fluid such as lubricating oil to support the rotating shaft 110 in a non-contact manner.

The first O-ring holder 181 can be mounted on an outer circumferential surface of the first bearing to surround the outer circumferential surface of the first bearing.

The first O-ring holder 181 can be defined in a cylindrical shape.

The first O-ring holder 181 can have a diameter the same as or similar to an outer diameter of the first bearing.

The first bearing can be press-fit to an inner circumferential surface of the first O-ring holder 181.

The first O-ring holder 181 can be accommodated in the first bearing receiving portion 151.

A first O-ring mounting groove 182 can be disposed concave in a radial direction along a circumferential direction on an outer circumferential surface of the first O-ring holder 181.

An O-ring can be mounted to be accommodated in the first O-ring mounting groove 182.

A plurality of first O-rings 183 can be made of an elastic material such as rubber.

The first O-ring mounting groove 182 can be disposed in plural on an outer circumferential surface of the first O-ring holder 181. In some examples, it is shown a configuration in which two first O-ring mounting grooves 182 are disposed.

The plurality of first O-ring mounting grooves 182 can be disposed to be spaced apart in an axial direction of the first O-ring holder 181.

The plurality of first O-rings 183 can be brought into close contact with the first bearing receiving portion 151.

In some implementations, the plurality of first O-rings 183 can align the concentricity of the first bearing. The plurality of first O-rings 183 can help to prevent the first O-ring holder 181 from rotating in the first bearing receiving portion 151.

The plurality of first O-rings 183 can attenuate vibrations and shocks transmitted from the outside to the first bearing.

The second bearing supporting the second support portion 114 can be implemented as a ball bearing 190.

A second O-ring holder 191 can be mounted on an outer circumferential surface of the ball bearing 190 to surround the ball bearing 190.

A plurality of second O-ring mounting grooves 192 can be disposed on an outer circumferential surface of the second O-ring holder 191. In some examples, it is shown a configuration in which two second O-ring mounting grooves 192 are disposed.

A plurality of second O-rings 193 can be mounted in the plurality of second O-ring mounting grooves 192, respectively.

The plurality of second O-rings 193 can align the concentricity of the second bearing. The plurality of second O-rings 193 can help to prevent the second O-ring holder 191 from rotating with respect to the second bearing receiving portion 171.

The plurality of second O-rings 193 are made of an elastic material such as rubber.

The plurality of second O-rings 193 can attenuate vibrations and shocks transmitted from the outside to the first bearing.

The ball bearing 190 can be composed of an outer ring, an inner ring, and a plurality of balls.

The outer ring is fixedly provided on an inner circumferential surface of the second O-ring holder 191. The inner ring is coupled to an outer circumferential surface of the second support portion 114. The plurality of balls are interposed between the outer ring and the inner ring to support a relative rotational movement of the inner ring with respect to the outer ring.

Therefore, the air bearing 180 is applied as a first bearing supporting the first support portion 112 of the rotating shaft 110 located adjacent to the impeller 120.

Since the air bearing 180 is lubricated with air with no additional working fluid, friction between the air bearing 180 and the rotating shaft 110 may not occur.

Due to this, even when the rotating shaft 110 rotates at a high speed above 100,000 rpm, wear due to friction between the air bearing 180 and the rotating shaft 110 may not occur, thereby extending the life of the bearing. Furthermore, the air bearing 180 can be applied to extend the life of the fan motor during high-speed rotation.

Furthermore, the air bearing 180 can have an advantage of extending the life even when the diameter is increased.

Accordingly, a diameter of the air bearing 180 can be increased to increase an axial diameter of a first support portion 112.

In addition, a diameter (thickness) of the first support portion 112 of the rotating shaft 110 adjacent to the impeller 120 can be increased (thickened) to prevent bending of the rotating shaft 110 due to uneven load of the impeller 120 during high-speed rotation. Furthermore, a thickness of the first support portion 112 can be increased to increase an allowable limit speed of the rotating shaft 110.

For example, a diameter of the first support portion 112 can be dispose to be larger than that of the impeller coupling portion 111 of the rotating shaft 110 to which the impeller 120 is coupled.

Furthermore, the diameter of the first support portion 112 can be disposed to be larger than that of the permanent magnet mounting portion 113 of the rotating shaft 110 on which the permanent magnet 141 is mounted.

Furthermore, the diameter of the first support portion 112 can be disposed to be larger than that of the second support portion 114 supported by the second bearing.

The rotating shaft 110 can be assembled such that the stator 130 is pre-assembled to an inner side of the shroud 100 and then disposed on the same center line of first receiving portion 102 and the second receiving portion 104 of the shroud 100 through a rotor receiving hole disposed inside the stator core 131.

In order for the first support portion 112 to be coupled to an inner circumferential surface of the first bearing through the rotor receiving hole, a diameter of the first support portion 112 can be disposed to be smaller than an inner diameter of the stator core 131.

In addition, an inner diameter of the first bearing can be disposed to be smaller than that of the stator core 131 to secure the assemblability of the rotating shaft 110 or the like.

In some examples, the air bearing 180 may not be disposed in the suction passage, the expansion passage 103, and the cooling passage 105, which are the main passages of the fan motor, and the impeller 120 can be disposed to cover the first bearing receiving portion 151 in which the air bearing 180 is accommodated, thereby blocking foreign substances such as dust from entering the air bearing 180.

In addition, the first O-ring mounting grooves 182 can be disposed on an outer wall of the first O-ring holder 181 surrounding the air bearing 180, and a plurality of first O-rings 183 can be mounted in the plurality of first O-ring mounting grooves 182, thereby allowing the rotating shaft 110 to be aligned in an axial direction on the center line of the shroud 100.

In addition, the first O-ring 183 can be formed of an elastic material, thereby attenuating shock transmitted from the outside to the first bearing.

In some implementations, the ball bearing 190 can be applied as a second bearing supporting the second support portion 114 of the rotating shaft 110 positioned at an opposite side of the impeller 120 with respect to the permanent magnet mounting portion 113.

Since the second support portion 114 of the rotating shaft 110 positioned at an opposite side of the impeller 120 is less affected from uneven load of the impeller 120, a shaft diameter of the second support portion 114 can be smaller than that of the first support portion 112.

For this reason, the ball bearing 190 can be applied to the second support portion 114. The ball bearing 190 is cheaper than the air bearing 180. Therefore, it is more advantageous in terms of cost to apply one air bearing 180 and one ball bearing 190 than to apply two air bearings 180 for bearings supporting both sides of the rotating shaft 110.

Furthermore, when using two bearings with only the air bearings 180, a thrust bearing, which is an essential element, should be used. However, when one air bearing 180 and one ball bearing 190 are applied, the use of the thrust bearing can be eliminated, thereby greatly contributing to the downsizing and weight reduction of the fan motor.

In addition, the first vane hub 160 and the second vane hub 163 can be disposed on a straight line with each other at a downstream side of the impeller 120 with respect to a flow direction of air generated by the impeller 120, and the cooling passage 105 disposed between the shroud 100 and the first and second vane hubs 163 can be disposed in a straight line without bending, thereby minimizing the flow resistance of air and increasing the cooling efficiency of the motor with air.

Moreover, a plurality of second vanes 164 can be disposed an outer circumferential surface of the second vane hub 163 to protrude into the cooling passage 105, and the plurality of second vanes 164 not only guide the flow of air, but also expand a heat exchange area between the air and the stator 130, thereby maximizing the cooling performance of the motor.

Moreover, a plurality of first fastening portions 154 can protrude downward in an axial direction in the first bearing housing 150. A plurality of second fastening portions 165 can protrude upward in an axial direction in the second vane hub 163. The first fastening portion 154 and the second fastening portion 165 can be disposed to overlap in a radial direction with the first vane hub 160 therebetween. A fastening member such as a screw can be fastened through the first fastening portion 154 of the first bearing housing 150, the first vane hub 160, and the second fastening portion 165 of the second bearing housing 170 to firmly fasten the first bearing housing 150, the first vane hub 160, and the second vane hub 163 disposed along an axial direction to each other, thereby greatly contributing to the downsizing and weight reduction of the motor with a simple and compact fastening structure.

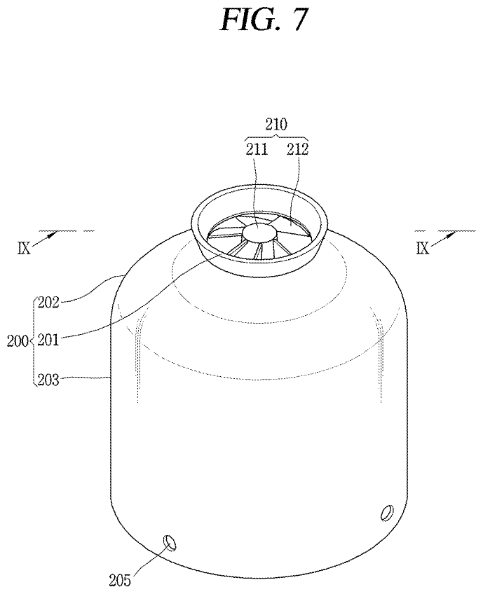

FIG. 7 is a perspective view showing the appearance of a fan motor.

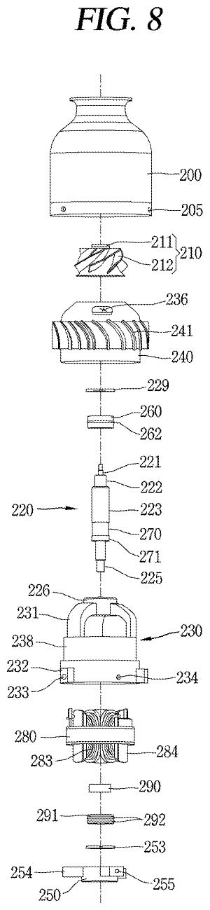

FIG. 8 is an exploded view of the fan motor in FIG. 7.

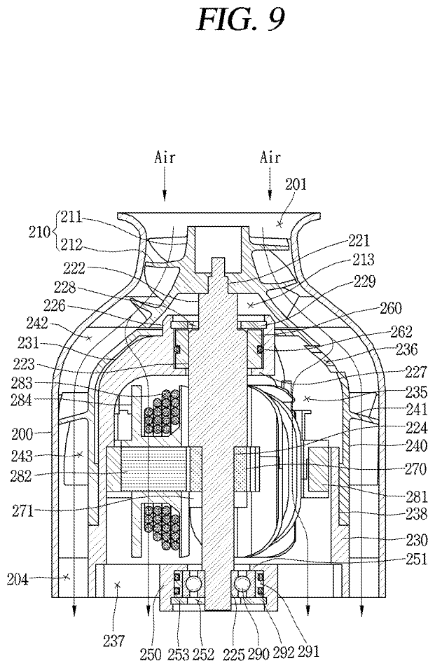

FIG. 9 is a cross-sectional view taken along line III-III in FIG. 7.

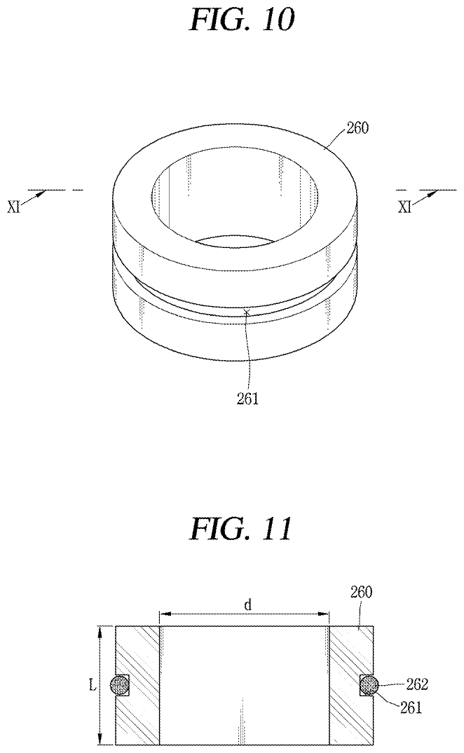

FIG. 10 is a perspective view showing an air bearing 260 in FIG. 9.

FIG. 11 is a cross-sectional view taken along line V-V in FIG. 9, showing a configuration in which a first O-ring 262 is mounted on an outer circumferential surface of the air bearing 260.

A fan motor can include a shroud 200, a rotating shaft 220, an impeller 210, a vane hub 240, a motor housing 230, a stator, a rotor, an air bearing 260, and a ball bearing 290.

The shroud 200 defined an appearance of the fan motor. The shroud 200 has a circular cross-sectional shape.

The shroud 200 has a receiving space therein.

The shroud 200 can be divided into a suction port 201, a first receiving portion 202, a second receiving portion 203, and a first discharge port 204 along a length direction (top-down or axial direction).

The suction port 201 and the first receiving portion 202 can each be defined in a conical shape.

The second receiving portion 203 can be defined in a cylindrical shape. The first discharge port 204 can be disposed at a lower end portion of the shroud 200.

The suction port 201 is disposed at an upper end portion of the shroud 200. External air can be suctioned into the shroud 200 through the suction port 201.

The suction port 201 can be defined in a shape in which a cone is turned upside down.

A bottle neck portion having a narrow cross-sectional area can be formed at a downstream side of the suction port 201 with respect to a flow direction of air. The flow speed of air in the bottle neck portion can be increased to increase the suction speed.

The first receiving portion 202 is disposed at a downstream side of the suction port 201 with respect to the flow direction of the air.

The second receiving portion 203 is disposed at a downstream side of the first receiving portion 202 with respect to the flow direction of the air.

The impeller 210 and the first bearing receiving portion 226 can be accommodated in the first receiving portion 202.

The first receiving portion 202 can be defined such that the cross-sectional area gradually increases from the bottleneck portion to the second receiving portion 203. An outer circumferential surface of the first receiving portion 202 can be disposed in a curved shape to be inclined toward the second receiving portion 203 from the bottleneck portion.

The second receiving portion 203 can be defined in a cylindrical shape having a diameter larger than that of the suction port 201 or an upper end portion of the first receiving portion 202.

The vane hub 240 and the motor housing 230 can be accommodated in the second receiving portion 203.

A plurality of fastening portions 232 can be provided at a lower end of the motor housing 230.

The plurality of fastening portions 232 can be disposed to protrude radially outward from an outer circumferential surface of the motor housing 230 toward an inner circumferential surface of the shroud 200.

An outer circumference of the plurality of fastening portions 232 can extend to be brought into contact with an inner circumferential surface of the shroud 200. A first fastening groove 233 can be disposed in a radial direction at each of the plurality of fastening portions 232. A plurality of first fastening holes 205 can be disposed at a lower end portion of the shroud 200 to pass therethrough in a thickness direction. The first fastening holes 205 can be disposed to overlap with the first fastening grooves 233 in a radial direction.

Fastening member such as screws can be fastened to the first fastening grooves 233 of the fastening portions 232 through the first fastening holes 205 of the shroud 200, thereby allowing the shroud 200 and the motor housing 230 to be fastened to each other.

The stator can be accommodated inside the motor housing 230.

The second bearing receiving portion 250 can be accommodated inside the motor housing 230.

The first discharge port 204 is disposed at a lower end of the second receiving portion 203. The plurality of first discharge ports 204 can be disposed between the plurality of fastening portions 232 protruding radially outward from an outer circumferential surface of the motor housing 230.

The first discharge port 204 can discharge air inside the second receiving portion 203 to the outside.

The rotating shaft 220 is disposed along the center line of the shroud 200 crossing the center of the shroud 200 in an axial direction.

The impeller 210 is configured to suction external air.

The impeller 210 includes a hub 211 and a plurality of blades 212.

The hub 211 is located at a center portion of the impeller 210. The hub 211 can be defined in a conical shape defined to increase in diameter from the upper end to the lower end.

A recess portion 213 can be disposed at a lower portion of the hub 211. The recess portion 213 can be disposed concave to an inside of the hub 211 in a conical shape. Part of the rotating shaft 220 can be disposed to be accommodated in the recess portion 213.

A fastening hole can be disposed inside the hub 211 to be fastened to one end portion of the rotating shaft 220.

The plurality of blades 212 can be disposed to protrude in a spiral shape on an outer circumferential surface of the hub 211. The plurality of blades 212 can be disposed to be spaced apart in a circumferential direction of the hub 211.

The plurality of blades 212 can be defined to increase in distance therebetween from the upper end to the lower end of the hub 211.

The plurality of blades 212 can be spaced apart from the first receiving portion 202 at a distance.

A suction passage can be disposed between the first receiving portion 202 and the hub 211.

The rotating shaft 220 can include an impeller coupling portion 221, a shaft connection portion 222, first support portion 223, a permanent magnet mounting portion 224, and a second support portion 225 defined with different diameters along an axial direction from the upper end to the lower end.

The impeller coupling portion 221 can be disposed at one end portion of the rotating shaft 220. The impeller coupling portion 221 can be coupled to the impeller 210 through a fastening hole, and the impeller 210 can rotate together with the rotating shaft 220.

The shaft connection portion 222 can be disposed to have a diameter larger than that of the impeller coupling portion 221. When the impeller coupling portion 221 is fastened to the fastening hole, the shaft connection portion 222 can be accommodated in the recess portion 213. One end portion of the shaft connection portion 222 is brought into close contact with the recess portion 213 to limit movement in an axial direction.

As the impeller 210 rotates, external air can flow in from the suction port 201 along the suction passage of the shroud 200.

Among portions of the rotating shaft 220 having different diameters, the first support portion 223 has the largest diameter. The first support portion 223 is located adjacent to the impeller 210.

A first bearing is coupled to the first support portion 223. The first bearing can be implemented as an air bearing 260.

The first bearing is configured to rotatably support the first support portion 223 of the rotating shaft 220.

The permanent magnet mounting portion 224 is located between the first support portion 223 and the second support portion 225.

The permanent magnet mounting portion 224 can have a smaller diameter than the first support portion 223.

A permanent magnet 270 of the rotor is mounted on the permanent magnet mounting portion 224 so as to surround an outer circumferential surface of the permanent magnet mounting portion 224.

The permanent magnet mounting portion 224 has a smaller diameter than that of the first support portion 223.

A diameter of the second support portion 225 is smaller than that of the permanent magnet mounting portion 224.

A second bearing is coupled to the second support portion 225. The second bearing can be implemented as a ball bearing 290.

The second bearing is disposed to rotatably support the second support portion 225 of the rotating shaft 220.

The ball bearing 290 can be composed of an outer ring, an inner ring, and a plurality of balls.

The outer ring is fixedly provided on an inner circumferential surface of an O-ring holder 291. The inner ring is coupled to an outer circumferential surface of the second support portion 225. The plurality of balls are interposed between the outer ring and the inner ring to support a relative rotational movement of the inner ring with respect to the outer ring.

The first support portion 223 and the second support portion 225 can be disposed at upper and lower portions of the rotating shaft 220 with the permanent magnet mounting portion 224 therebetween. The second support portion 225 can be located at an opposite side of the impeller coupling portion 221 in an axial direction.

The first bearing receiving portion 226 is disposed at a downstream side of the impeller 210 to be spaced apart at a predetermined distance.

The first bearing receiving portion 226 can be defined in a cylindrical shape. The air bearing 260 is accommodated in the first bearing receiving portion 226.

The first bearing receiving portion 226 can be disposed to be open upward toward the impeller 210.

The first bearing receiving portion 226 can have a diameter larger than that of the first support portion 223 and the air bearing 260.

A first axial movement limiting portion 227 can extend from a lower end of the first bearing receiving portion 226 to a radially inner side thereof.

A through hole can be disposed inside the first axial movement limiting portion 227. A diameter of the through hole can be disposed to be larger than that of the first support portion 223 and smaller than that of the air bearing 260.

According to this configuration, the first axial movement limiting portion 227 can limit movement in an axial direction toward the rotor while the air bearing 260 is accommodated in the first bearing receiving portion 226.

A first snap ring receiving groove 228 can be disposed radially outward from an upper end of the first bearing receiving portion 226.

The first snap ring receiving groove 228 is mounted to accommodate a first snap ring 229 therein. The first snap ring 229 can be defined in a “C” shape. The first snap ring 229 is defined in a ring shape with one side open to be elastically deformable such that an open area inside the first snap ring 229 expands or contracts in a radial direction.

The first snap ring 229 can be defined slightly larger than the first bearing receiving portion 226 to insert the outer diameter into the first snap ring receiving groove 228, and the inner diameter can be defined smaller than the air bearing 260.

The first snap ring 229 can help to prevent the air bearing 260 from being axially separated from the first bearing receiving portion 226 toward the impeller 210 while being accommodated in the first snap ring receiving groove 228.

An upper end portion of the first bearing receiving portion 226 is accommodated in the recess portion 213 disposed at a lower side of the hub 211.

The hub 211 of the impeller 210 is disposed to overlap with the first bearing receiving portion 226 in an axial direction so as to cover an upper opening portion of the first bearing receiving portion 226 that is open.

According to this configuration, the hub 211 can block foreign substances such as dust in air suctioned by the impeller 210 from flowing into the air bearing 260.

The vane hub 240 can be defined in a combination of hollow conical and cylindrical shapes.

A conical portion can be disposed at an upper portion of the vane hub 240, and a cylindrical portion can be disposed at a lower portion of the vane hub 240.

The conical portion of the vane hub 240 can be defined to gradually increase in diameter from an upstream side to a downstream side with respect to a flow direction of air.

A ratio of increasing the diameter from the top to the bottom of the conical portion of the vane hub 240 in the axial direction is greater than that of increasing the diameter from the upper end to the lower end of the hub 211.

In other words, an inclination of an outer surface of the hub 211 is steeper than that of an outer surface of the vane hub 240.

An upper end of the vane hub 240 can be defined to have a slightly larger diameter than a lower end of the hub 211.

According to this configuration, it is possible to minimize a flow resistance of air.

An expansion passage 242 can be disposed between the first receiving portion 202 and the vane hub 240. The expansion passage 242 is a passage for transferring air suctioned from the suction passage to vanes 241 which will be described later.

The expansion passage 242 can be disposed such that a diameter of the passage increases from the impeller 210 to the vanes 241.

An opening portion is disposed at an upper end of the conical portion of the vane hub 240. An upper end portion of the first bearing receiving portion 226 can protrude through the opening portion, and can be received into the conical portion of the vane hub 240 under the upper end portion of the first bearing receiving portion 226.

The motor housing 230 is disposed at a downstream side of the vane hub 240 with respect to a flow direction of air.

An outer circumferential surface of the motor housing 230 can be coupled to an inner circumferential surface of the vane hub 240. An outer circumferential surface of the motor housing 230 and an inner circumferential surface of the vane hub 240 can be bonded to each other by an adhesive element such as an adhesive.

The first bearing receiving portion 226 can be disposed at an upstream side of the motor housing 230 to be spaced apart.

The first bearing receiving portion 226 and the motor housing 230 can be connected by a plurality of first bridges 231.

One side of each of the plurality of first bridges 231 can be defined to be connected to an outer circumferential surface of the first bearing receiving portion 226, and the other side of each of the plurality of first bridges 231 can be defined to be connected to an upper end of the motor housing 230.

The motor housing 230 is defined to have a larger diameter than that of the first bearing receiving portion 226.

Each of the plurality of first bridges 231 can include a straight portion extending directly upward from the motor housing 230 and an inclined portion extending upward in an inclined manner toward an outer circumferential surface of the first bearing receiving portion 226 from the straight portion.

The plurality of first bridges 231 can be disposed to be spaced apart in a circumferential direction of the motor housing 230 or the first bearing receiving portion 226.

An opening portion between the plurality of first bridges 231 can be disposed to be open in a radial direction.

The conical portion and the cylindrical portion of the vane hub 240 are configured to cover an opening portion between the first bridge 231. Part of the conical portion and the cylindrical portion of the vane hub 240 can be disposed to surround the plurality of first bridges 231 and to overlap in radial and top-down directions.

An inner passage 235 can be disposed along an axial direction inside the vane hub 240 and inside the motor housing 230 to allow air to flow into the motor housing 230.

A plurality of communication holes 236 can be disposed in the conical portion of the vane hub 240. The plurality of communication holes 236 can connect the expansion passage 242 of the first receiving portion 202 and the inner passage 235 of the motor housing 230 to communicate with each other. The plurality of communication holes 236 can be disposed to be spaced apart in a circumferential direction of the vane hub 240.

According to this configuration, air suctioned by the impeller 210 can be branched from the expansion passage 242 through the communication hole 236 to flow into the inner passage 235 of the motor housing 230.

The cylindrical portion of the vane hub 240 can be defined in a cylindrical shape having a constant diameter in an axial direction.

An outer passage 243 can be disposed between the second receiving portion 203 and an outer circumferential surface of the cylindrical portion of the vane hub 240.

An opening portion disposed between the plurality of first bridges 231 can be disposed to communicate with the communication hole 236, and can also be connected to communicate with the inner passage 235.

The outer passage 243 is disposed at a downstream side of the expansion passage 242. Part of air suctioned by the impeller 210 can flow into the inner passage 235 through the communication hole 236 from the expansion passage 242, and another part of the suctioned air can move from the expansion passage 242 to the outer passage 243.

In some examples, a connection ring can be mounted on an inner circumferential surface of the vane hub 240. The vane hub 240 is configured to surround a circular connection ring. The connection ring is configured to connect an end (neutral line) of a three-phase stator coil 283.

A surrounding groove 238 can be disposed concave on an outer circumferential surface of the motor housing 230 to a depth equal to a thickness of the vane hub 240. Accordingly, the vane hub 240 is inserted and coupled to the surrounding groove 238, and thus a step difference between the motor housing 230 and the vane hub 240 may not occur.

The vane hub 240 and the motor housing 230 can be joined by the surrounding groove 238.

A plurality of vanes 241 can be disposed to protrude along a spiral direction on an outer circumferential surface of the vane hub 240.

The plurality of vanes 241 are disposed to be spaced apart in a circumferential direction of the vane hub 240.

The vane hub 240 and the vanes 241 can be integrally formed. The vanes 241 are configured to guide air flowing in through the expansion passage 242 to the outer passage 243.

The plurality of vanes 241 can be coupled to an inside of the second receiving portion 203 of the shroud 200 in a forcibly fitting manner.

The motor housing 230 is configured to surround the stator.

The stator can be mounted to be press-fit into the motor housing 230.

The stator includes a stator core 280 and a stator coil 283.

The stator core 280 can be adhered to upper inner circumferential surface of the motor housing 230 by an adhesive element such as an adhesive.

The stator core 280 can include a back yoke 281 and a plurality of teeth 282.

The back yoke 281 can be defined in a ring shape. Each of the plurality of teeth 282 is disposed to protrude in a radial direction from an inner surface of the back yoke 281 toward the center of the back yoke 281.

The plurality of teeth 282 can be disposed to be detachable from the back yoke 281. In some examples, the plurality of teeth 282 can have three teeth.

A coupling protrusion can be disposed to protrude from one end portion of each of the plurality of teeth 282.

The coupling protrusion can be slidably coupled in an axial direction along a coupling groove disposed at an inner side of the back yoke 281.

A pole shoe can be disposed to protrude in a circumferential direction at the other end portion of each of the plurality of teeth 282. The plurality of teeth 282 are disposed to be spaced apart in a circumferential direction of the back yoke 281.

The stator coil 283 can be configured as a three-phase coil. The plurality of stator coils 283 can be wound around the teeth 282 for each phase in the form of a concentrated winding.

In some implementations, a tooth segmentation core of the teeth 282 and a concentrated winding structure of the coil can improve the output of the motor and enable the downsizing and weight reduction of the motor.

An insulator 284 insulating between the stator core 280 and the stator coil 283 can be interposed between the stator core 280 and the stator coil 283. The insulator 284 can include a teeth insulator 284 disposed to surround part of the teeth 282 and a back yoke insulator 284 disposed to cover part of the back yoke 281. The insulator 284 is formed of an insulating material such as plastic.

The rotor is configured to include a permanent magnet 270.

The permanent magnet 270 can be mounted on an outer circumferential surface of the permanent magnet mounting portion 224.

The permanent magnet mounting portion 224 is disposed to have a small diameter from a lower end to an axial lower portion of the first support portion 223.

The permanent magnet 270 is disposed to have a diameter smaller than an inner diameter of the stator core 280.

The inner diameter of the stator core 280 denotes a diameter of circumference passing through inner ends of the plurality of pole shoes in a circumferential direction.

The permanent magnet 270 and the first support portion 223 can be disposed to have the same diameter.

The permanent magnet 270 can be rotatably mounted on the permanent magnet mounting portion 224 of the rotating shaft 220 with an air gap radially inward with respect to the pole shoes of the stator core 280.

In order to limit the movement of the permanent magnet 270 in an axial direction, an end cap 271 can be provided at a downstream side of the permanent magnet mounting portion 224. The end cap 271 can be defined in a cylindrical shape having the same diameter as the permanent magnet 270.

One side of the permanent magnet 270 can be brought into contact with the first support portion 223 having a diameter larger than that of the permanent magnet mounting portion 224, thereby limiting upstream movement in an axial direction.

The end cap 271 is fixedly provided at a downstream side of the permanent magnet 270.

The end cap 271 can be defined in a hollow cylindrical shape to allow the permanent magnet mounting portion 224 to pass therethrough.

The other side of the permanent magnet 270 can be limited from moving to the downstream side along an axial direction by the end cap 271.

When three-phase alternating current is applied to each of a plurality of stator coils 283, the permanent magnet 270 can electromagnetically interact with a magnetic field generated around the stator coil 283 to generate a rotational force.

According to this configuration, the rotating shaft 220 can rotate due to electromagnetic interaction between the rotor and the stator.

The stator coil 283 and the stator core 280 are configured to exchange heat with air flowing along the inner passage 235.

According to this configuration, heat generated from the stator coil 283 and the stator core 280 can be cooled by heat exchange between the stator and air.

The outer passage 243 can be disposed between the second receiving portion 203 and the vane hub 240.

The outer passage 243 can be defined in a straight line shape along an axial direction to minimize flow resistance.

Air can move along two movement paths inside the shroud 200. Looking at a first movement path, air is suctioned into the shroud 200 through the suction port 201, and part of the suctioned air is discharged to the outside through the first discharge port 204 while moving along the outer passage 243 through the suction passage and the expansion passage 242.

Looking at a second movement path, another part of the suctioned air flows into the inner passage 235 of the vane hub 240 through the plurality of communication holes 236 from the expansion passage 242.

The air flowing along the inner passage 235 can cool the heat of the stator while exchanging heat with the stator coil 283, and then can be discharged to the outside through the second discharge port 237. A plurality of second discharge ports 237 can be provided inside a lower end of the motor housing 230.

The second bearing receiving portion 250 is disposed at a lower end portion of the motor housing 230.

The second bearing receiving portion 250 can be disposed at an inner central portion of the motor housing 230.

The second bearing receiving portion 250 can be defined in a ring shape.

The second bearing is mounted to be accommodated in the second bearing receiving portion 250.

The second bearing can be implemented as a ball bearing 290.

A second axial movement limiting portion 251 can extend radially inward from an upper end of the second bearing receiving portion 250.

A through hole can be disposed inside the second axial movement limiting portion 251. A diameter of the through hole can be disposed to be larger than that of the second support portion 225 and the permanent magnet mounting portion 224.

The second axial movement limiting portion 251 can protrude radially inward with an inner diameter smaller than an outer diameter of the second bearing. Accordingly, the second bearing can limit movement in an axial direction toward the permanent magnet mounting portion 224 while being accommodated in the second bearing receiving portion 250.

The second bearing receiving portion 250 can be disposed to be open downward.

A second snap ring receiving groove 252 can be disposed at a lower end of the second bearing receiving portion 250 to be concave radially outward.

The second snap ring 253 can be mounted to be accommodated in the second snap ring receiving groove 252.

The second snap ring 253 can help to prevent the second bearing from being separated from the second bearing receiving portion 250 to the outside while being accommodated in the second snap ring receiving groove 252.

A plurality of second bridges 254 can be disposed on an outer circumferential surface of the second bearing receiving portion 250.

Each of the plurality of second bridges 254 is disposed to protrude radially outward.

An outer circumference of the plurality of second bridges 254 can be disposed to be in contact with an inner circumferential surface of a lower end portion of the motor housing 230.

A plurality of second fastening holes 234 can be disposed at a lower end of the motor housing 230 to pass therethrough in a radial direction.

The plurality of second fastening holes 234 and the plurality of fastening portions 232 can be alternately spaced apart from each other along a circumferential direction of the motor housing 230.

A plurality of second fastening grooves 255 can be disposed on an outer circumference of the plurality of second bridges 254 to overlap with the plurality of second fastening holes 234 in a radial direction, respectively.

A plurality of fastening members, such as screws can be fastened to the plurality of second fastening grooves 255, respectively, through the plurality of second fastening holes 234 to mount the second bearing receiving portion 250 on an inner side of the motor housing 230 by the plurality of second bridges 254.

The plurality of second discharge ports 237 can be disposed between the plurality of second bridges 254.

The plurality of second discharge ports 237 and the plurality of second bridges 254 can be alternately spaced apart in a circumferential direction inside the motor housing 230.

In some examples, a plurality of bus bars can be provided at an inner side of a lower end portion of the motor housing 230. The plurality of bus bars can be disposed in the second discharge ports 237.

The plurality of bus bars are respectively connected to the three-phase stator coil 283 to apply three-phase alternating currents (AC).

The first bearing receiving portion 226 can be integrally formed in the motor housing 230 by the plurality of first bridges 231, and the vane hub 240 and the motor housing 230 can be disposed to overlap with each other in a radial direction and bonded to each other by an adhesive, and made of a simple fastening structure while being firmly fastened to each other, and compactly disposed to contribute to downsizing and weight reduction.

The plurality of fastening portions 232 can be disposed to protrude from an outer circumferential surface of the motor housing 230, and the plurality of fastening portions 232 can be fastened to a lower end portion of the shroud 200 by screws or the like, thereby further improving a fastening force between the shroud 200 and the motor housing 230.

The plurality of fastening portions 232 and the plurality of second bridges 254 can be disposed not to overlap with each other in a radial direction at outer and inner sides of the motor housing 230.

The plurality of fastening portions 232 and the plurality of second bridges 254 can be disposed to be spaced apart in a circumferential direction with different phase differences at outer and inner sides of the motor housing 230, respectively.

If the plurality of fastening portions 232 and the plurality of second bridges 254 are disposed to overlap in a radial direction, fastening members for fastening the shroud 200 and the motor housing 230 and fastening members for fastening the motor housing 230 and the second bearing receiving portion 250 can be disposed to overlap each other in a radial direction, thereby causing difficulty in fastening individual fastening members to different parts, respectively.

Therefore, a fastening position between the shroud 200 and the fastening portions 232 of the motor housing 230 and a fastening position between the motor housing 230 and the second bridges 254 of the second bearing receiving portion 250 can be disposed to be spaced apart in a circumferential direction to have different phase angles, thereby securing the downsizing and assemblability of the motor in spite of a small assembly space.

Referring to FIGS. 10 and 11, the first bearing supporting the first support portion 223 can be implemented as an air bearing 260.

The air bearing 260 can be defined in a hollow cylindrical shape. A shaft receiving portion is disposed inside the air bearing 260.

The air bearing 260 is disposed to form an air gap between an outer circumferential surface of the first support portion 223 and an inner circumferential surface of the air bearing 260.

The air gap can be 0.04 mm or less.

In order to secure the assemblability of the rotating shaft 220 and the rotor, an inner diameter of the air bearing 260 can be disposed to be smaller than that of the stator core 280.

An inner diameter of the stator core 280 denotes a diameter of a circle passing through inner end portions of the plurality of teeth 282 in a circumferential direction.

An inner diameter (d) of the air bearing 260 can be disposed to be larger than a length (height) of the air bearing 260 in order to reduce wear of an inner diameter surface of the air bearing 260.

A ratio of a length (L) of the air bearing 260 to the inner diameter (d) of the air bearing 260 can be 0.7 or less. When the length/inner diameter (L/d) ratio of the air bearing 260 exceeds 0.7, an amount of wear on an inner diameter surface of the air bearing 260 can be greatly increased.

Since the air bearing 260 rotatably supports the rotating shaft 220 in a non-lubricating state, a material having a low coefficient of friction and excellent wear resistance is used.

For example, the air bearing 260 can be made of a polyetheretherketone (PEEK) or polyaryletherketone (PAEK) material having excellent non-lubricating friction characteristics and wear resistance.

PEEK or PAEK has low wear on the bearing after operation and small change in gap with the shaft.

The air bearing 260 can form an air layer between the rotating shaft 220 and an inner circumferential surface of the air bearing 260 with no additional working fluid such as lubricating oil to support the rotating shaft 220 in a non-contact manner.

At least one or more first O-rings 262 can be mounted on an outer circumferential surface of the first bearing. In some examples, it is shown a configuration in which one first O-ring 262 is mounted.

The air bearing 260 can be accommodated in the first bearing receiving portion 226.

The first O-ring mounting groove 261 can be disposed concave in a radial direction along a circumferential direction on an outer circumferential surface of the air bearing 260.

The first O-ring 262 can be mounted to be accommodated in the first O-ring mounting groove 261.

A plurality of first O-rings 262 are made of an elastic material such as rubber.

A plurality of first O-ring mounting grooves 261 can be disposed to be spaced apart in a length direction (axial direction) of the air bearing 260.

The plurality of first O-rings 262 are brought into close contact with the first bearing receiving portion 226.

According to this configuration, the plurality of first O-rings 262 can align the concentricity between the air bearing 260 and the first bearing receiving portion 226 on the same center line. The plurality of first O-rings 262 can help to prevent the air bearing 260 from rotating in the first bearing receiving portion 226.

The plurality of first O-rings 262 can attenuate vibrations and shocks transmitted from the outside to the air bearing 260.

The second bearing supporting the second support portion 225 can be implemented as a ball bearing 290.

An O-ring holder 291 can be mounted on an outer circumferential surface of the ball bearing 290 to surround the ball bearing 290.

A plurality of second O-ring mounting grooves 292 can be disposed on an outer circumferential surface of the O-ring holder 291. In some examples, it is shown a configuration in which two second O-ring mounting grooves 292 are disposed.

A plurality of second O-rings 293 can be mounted in the plurality of second O-ring mounting grooves 292, respectively.

The plurality of second O-rings 293 can align the concentricity between the ball bearing 290 and the second bearing receiving portion 250 on the same center line. The plurality of second O-rings 293 can help to prevent the ball bearing 290 from rotating with respect to the second bearing receiving portion 250.

The plurality of second O-rings 293 are made of an elastic material such as rubber.

The plurality of second O-rings 293 can attenuate vibrations and shocks transmitted from the outside to the ball bearing 290.

Therefore, the air bearing 260 is applied as a first bearing supporting the first support portion 223 of the rotating shaft 220 located adjacent to the impeller 210.

Since the air bearing 260 is lubricated with air with no additional working fluid, friction between the air bearing 260 and the rotating shaft 220 may not occur.

Due to this, even when the rotating shaft 220 rotates at a high speed above 100,000 rpm, wear due to friction between the air bearing 260 and the rotating shaft 220 may not occur, thereby extending the life of the bearing. Furthermore, the air bearing 260 can be applied to extend the life of the fan motor during high-speed rotation.

Furthermore, the air bearing 260 can have an advantage of extending the life even when the diameter is increased.

Accordingly, a diameter of the air bearing 260 can be increased to increase an axial diameter of a first support portion 223.

In addition, a diameter (thickness) of the first support portion 223 of the rotating shaft 220 adjacent to the impeller 210 can be increased (thickened) to prevent bending of the rotating shaft 220 due to uneven load of the impeller 210 during high-speed rotation. Furthermore, a thickness of the first support portion 223 can be increased to increase an allowable limit speed of the rotating shaft 220.

For example, a diameter of the first support portion 223 can be dispose to be larger than that of the impeller coupling portion 221 of the rotating shaft 220 to which the impeller 210 is coupled.

Furthermore, the diameter of the first support portion 223 can be disposed to be larger than that of the permanent magnet mounting portion 224 of the rotating shaft 220 on which the permanent magnet 270 is mounted.

Furthermore, the diameter of the first support portion 223 can be disposed to be larger than that of the second support portion 225 supported by the second bearing.

The rotating shaft 220 passes through the rotor receiving hole formed inside the stator core 280 after the stator is pre-assembled inside the shroud 200 to accommodate the first receiving portion 202 and the second receiving portion of the shroud 200. It is assembled to be disposed on the same center line of the second receiving portion 203.

In order for the first support portion 223 to be coupled to an inner circumferential surface of the first bearing through the rotor receiving hole, a diameter of the first support portion 223 can be disposed to be smaller than an inner diameter of the stator core 280.

In addition, an inner diameter of the air bearing 260 can be disposed to be smaller than that of the stator core 280 to secure the assemblability of the rotating shaft 220 or the like.

For example, while the ball bearing 290 is coupled to the second support portion 225, the first support portion 223 of the rotating shaft 220 can be allowed to be assembled to an inner side of the air bearing 260.

In some examples, the air bearing 260 may not be disposed in the suction passage, the expansion passage 242, and the outer passage 243, which are the main passages of the fan motor, and the impeller 210 can be disposed to cover the first bearing receiving portion 226 in which the air bearing 260 is accommodated, thereby blocking foreign substances such as dust from entering the air bearing 260.

In addition, the first O-ring mounting grooves 261 can be disposed on an outer wall of the air bearing 260, and the first O-rings 262 can be mounted in the first O-ring mounting grooves 261, thereby allowing the rotating shaft 220 to be aligned in an axial direction on the center line of the shroud 200.

Moreover, the first O-rings 262 can be formed of an elastic material, thereby attenuating shock transmitted from the outside to the air bearing 260.

In some implementations, the ball bearing 290 can be applied as a second bearing supporting the second support portion 225 of the rotating shaft 220 positioned at an opposite side of the impeller 210 with respect to the permanent magnet mounting portion 224.

Since the second support portion 225 of the rotating shaft 220 positioned at an opposite side of the impeller 210 is less affected from uneven load of the impeller 210, a shaft diameter of the second support portion 225 can be smaller than that of the first support portion 223.

For this reason, the ball bearing 290 can be applied to the second support portion 225. The ball bearing 290 is cheaper than the air bearing 260. Therefore, it is more advantageous in terms of cost to apply one air bearing 260 and one ball bearing 290 than to apply two air bearings 260 for bearings supporting both sides of the rotating shaft 220.

Furthermore, when using two bearings with only the air bearings 260, a thrust bearing, which is an essential element, should be used. However, when one air bearing 260 and one ball bearing 290 are applied, the use of the thrust bearing can be eliminated, thereby greatly contributing to the downsizing and weight reduction of the fan motor.

In addition, the vane hub 240 and the motor housing 230 can be disposed on a straight line with each other at a downstream side of the impeller 210 with respect to a flow direction of air generated by the impeller 210, and the outer passage 243 disposed between the shroud 200 and the vane hub 240 and motor housing 230 can be disposed in a straight line without bending, thereby minimizing the flow resistance of air and increasing the cooling efficiency of the motor with air.

Moreover, the plurality of vanes 241 protruding from an outer circumferential surface of the vane hub 240 can be coupled to an inner circumferential surface of the shroud 200 in a forcibly fitting manner, thereby allowing the shroud 200 and the vane hub 240 to be firmly fastened to each other.

The first bearing receiving portion 226 and the motor housing 230 can be integrally connected by the plurality of first bridges 231.

The vane hub 240 and the motor housing 230 can be disposed to overlap in a radial direction and bonded to each other by an adhesive, thereby firmly fastening to each other.

The plurality of fastening portions 232 can protrude radially outward on an outer circumferential surface of the motor housing 230, and the plurality of fastening portions 232 can be fastened to an inner circumferential surface of the shroud 200 by screws or the like, thereby allowing the shroud 200 and the motor housing 230 to be firmly coupled to each other.

The second bearing receiving portion 250 and the motor housing 230 can be connected to each other by the plurality of second bridges 254, and the motor housing 230 and the second bridges 254 can be connected to each other by fastening members such as screws, thereby greatly contributing to the downsizing and weight reduction of the motor with a simple and compact fastening structure.

In addition, a fastening position between the shroud 200 and the fastening portions 232 of the motor housing 230 and a fastening position between the motor housing 230 and the second bridges 254 of the second bearing receiving portion 250 can be disposed to be spaced apart in a circumferential direction to have different phase angles, thereby securing the downsizing and assemblability of the motor in spite of a small assembly space.

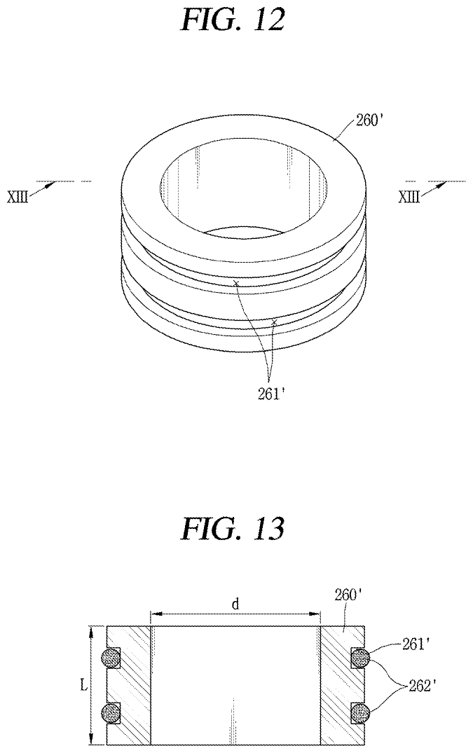

FIG. 12 is a perspective view showing an example of a first O-ring mounting groove 261′ on an air bearing 260′.

FIG. 13 is a cross-sectional view taken along line XIII-XIII of FIG. 12, showing a configuration in which a plurality of first O-rings 262′ are mounted on the first O-ring mounting grooves 261′ of the air bearing 260′.

The example shown in FIG. 13 may be different from the foregoing examples shown in FIGS. 7 through 11 in that the plurality of first O-ring mounting grooves 261′ are disposed along a circumferential direction on an outer circumferential surface of the air bearing 260′.

The plurality of first O-ring mounting grooves 261′ are disposed to be spaced apart in a length direction (axial direction) of the air bearing 260′. The plurality of first O-rings 262′ can be mounted to be respectively accommodated in the plurality of first O-ring mounting grooves 261′.

Other components are the same or similar to those of the examples of FIGS. 7 through 11, and thus a redundant description thereof will be omitted.

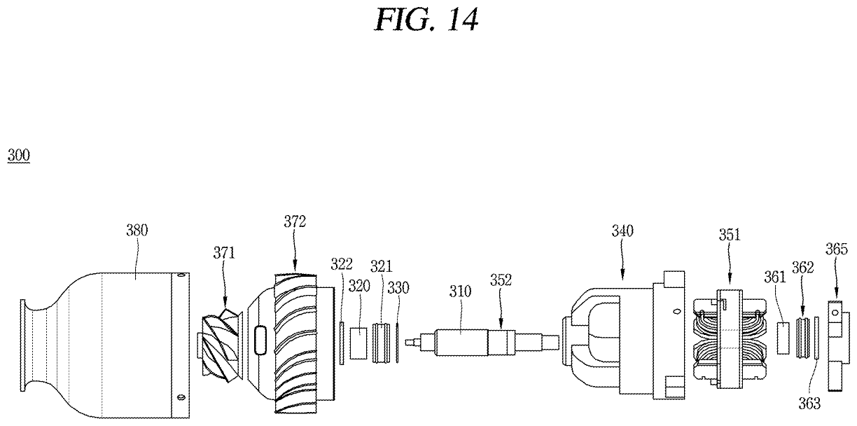

FIG. 14 is an exploded perspective view showing an example of a fan motor.

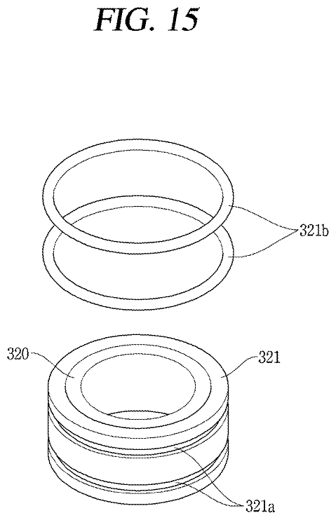

FIG. 15 is a perspective view showing a bearing portion and a holder portion illustrated in FIG. 14.

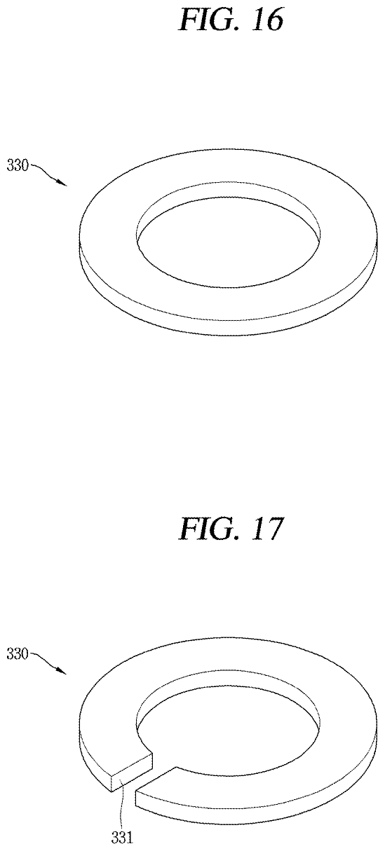

FIG. 16 is a perspective view showing a sealing portion illustrated in FIG. 14.

FIG. 17 through 22B are views showing other examples of the sealing portion shown in FIG. 16.

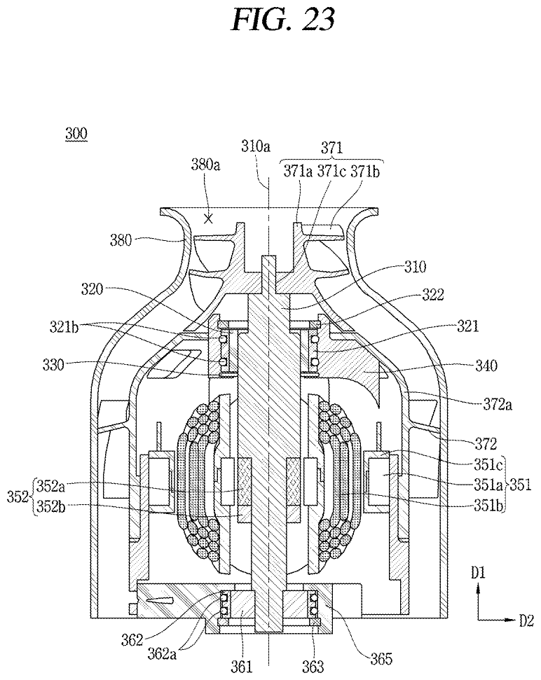

FIG. 23 is a cross-sectional view showing a configuration of the fan motor illustrated in FIG. 14 in an assembled state.

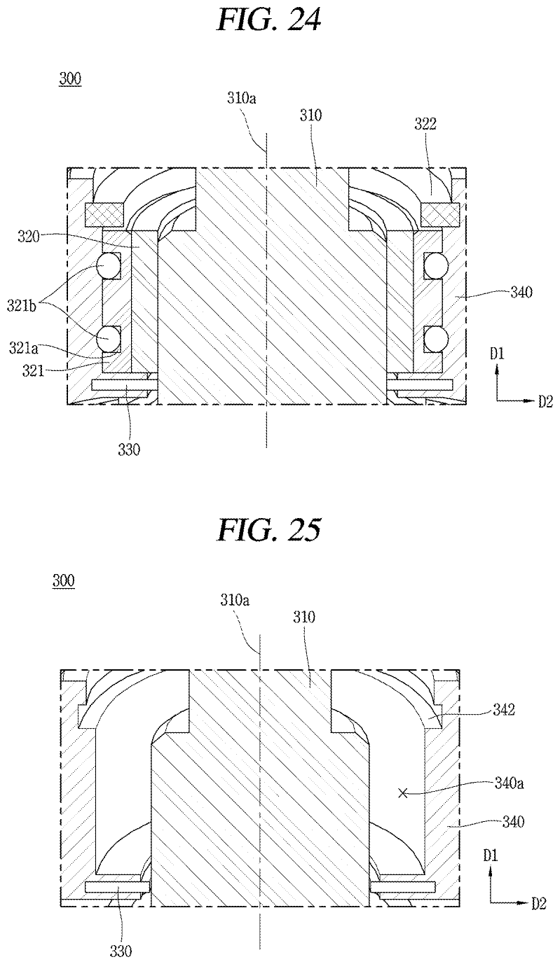

FIG. 24 is an enlarged view showing part of a fan motor around a bearing portion illustrated in FIG. 23.

FIG. 25 is a view showing an inner space of a housing portion except for the bearing portion and a snap ring illustrated in FIG. 24.

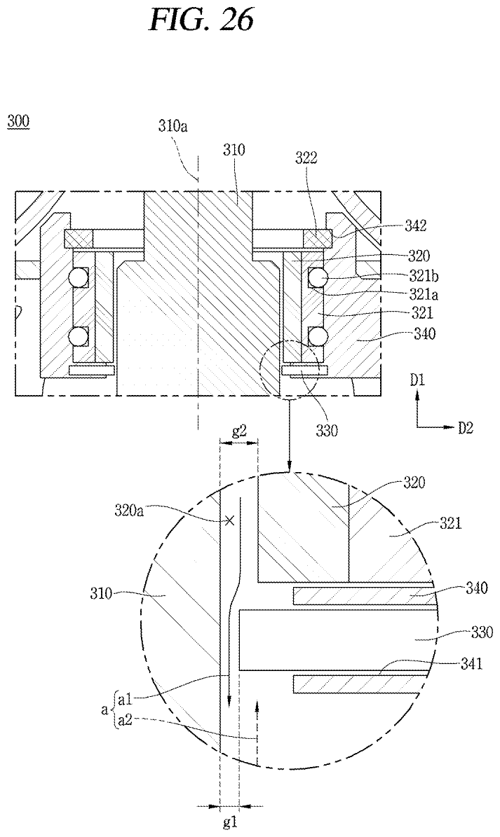

FIG. 26 is a conceptual view showing part of the fan motor enlarged around the bearing portion illustrated in FIG. 24.

Referring to FIGS. 14 through 26, the fan motor 300 includes a rotating shaft 310, a bearing portion 320 and a sealing portion 330.

The rotating shaft 310 can be disposed to extend in one direction, and coupled to the rotor 352 so as to rotate in one direction together while the rotor 352 rotates.

The rotating shaft 310 can be configured to rotate around a central axis extending along the shaft 310a defined along a length direction (D1) of the rotating shaft 310.

In some implementations, a radial direction (D2) of the rotating shaft 310 can be defined as a direction perpendicular to the length direction (D1) of the rotating shaft 310.

The rotor 352 can be disposed inside the stator 351. Furthermore, the rotor 352 can be configured to rotate in one direction by a rotating magnetic field generated by the stator 351.

The rotor 352 can include a magnet portion 352a disposed to surround part of the rotating shaft 310 and an end-cap provided at one end portion of the magnet portion 352a. The magnet portion 352a can be configured to have magnetism.

The stator 351 can include a stator core 351a, a stator coil 351b, and an insulator 351c.

The stator coil 351b can be provided in plural, and can be wound around the stator core 351a.

In addition, the insulator 351c can be provided between the stator core 351a and the stator coil 351b to electrically insulate between the stator core 351a and the stator coil 351b.

In some implementations, an impeller 371 can be coupled and fixed to one end portion of the rotating shaft 310.

The impeller 371 can include a hub 371a constituting a body of the impeller 371 and a plurality of blades 371b protruding from an outer surface of the hub 371a along a circumference of the hub 371a. A through hole 371c through which one end portion of the rotating shaft 310 is inserted can be provided in the hub 371a.

The impeller 371 can generate an air current during rotation. In addition, the fan motor 300 can include a vane 372 that guides the air current generated by the impeller 371. The vane 372 can be disposed on the vane body 372a along a circumference of the vane body 372a.

The impeller 371 and the vane 372 can be disposed to be surrounded by a shroud 380. The shroud 380 can define an appearance of the fan motor 300.

At one side of the shroud 380 adjacent to the impeller 371, an opening portion 380a can be provided to allow air to flow into the impeller 371 from the outside.

In some examples, a ball bearing 361 that supports the self-weight of the rotation shaft 310 and a load applied to the rotation shaft 310 while fixing the rotation shaft 310 together with the bearing portion 320 at a predetermined position can be provided at the other side of the rotating shaft 310.

The bearing portion 320 and the ball bearing 361 can be disposed to surround different portions of the rotating shaft 310, respectively.

The ball bearing 361 can be configured with a type of rolling bearing. The fan motor 300 can include a ball bearing housing 365 disposed to surround the ball bearing 361 to accommodate the ball bearing 361.

In addition, a ball bearing holder 362 disposed to surround the ball bearing 361 can be provided between the ball bearing 361 and the ball bearing housing 362.

Furthermore, a ball bearing O-ring 362a can be provided between the ball bearing holder 362 and the ball bearing housing 365 to seal a gap existing between the ball bearing holder 362 and the ball bearing housing 365. The ball bearing O-ring 362a can be provided in plural.

In some examples, a ball bearing snap ring 363 configured to support the ball bearing 361 and/or the ball bearing holder 362 while being coupled to the ball bearing housing 365 can be disposed at one side of the ball bearing 361 on a length direction (D1) of the rotating shaft 310. The ball bearing snap ring 363 can function to prevent the rotating shaft 310 and the ball bearing 361 from being separated to the outside.

Hereinafter, the bearing portion 320 and the sealing portion 330 included in the fan motor 300 will be described.

The bearing portion 320 is disposed to surround part of the rotating shaft 310. For example, the bearing portion 320 can be disposed at a position relatively adjacent to the impeller 371 compared to the ball bearing 361.

One surface of the bearing portion 320 facing the rotating shaft 310 can be spaced apart from the rotating shaft 310 at a predetermined distance to define a gap 320a through which air (a) flows.

In this specification, the bearing portion 320 can be referred to as an air bearing.

Here, the air (a) can include foreign substances such as dust. Furthermore, foreign substances such as dust can be moved or floated by an air current generated during the operation of the fan motor 300 to flow into the gap 320a.

Unlike the ball bearing 361, the bearing portion 320 is configured to support the rotating shaft 310 by the air (a) flowing through the gap 320a defined between the rotating shaft 310 and the bearing portion 320. As such, the bearing portion 320 has a structure in which the operating region of the bearing portion 320 is open. Furthermore, a distance between the rotating shaft 310 and the bearing portion 320 defining the gap 320a can be approximately 40 μm.

In addition, the air current due to the air (a) entering and leaving the gap 320a can include a first air current (a1) generated from the gap (320a) to an outside of the gap 320a and a second air current (a2) flowing into the gap 320a from a region outside the gap 320a as shown in FIG. 26.

In some implementations, the fan motor 300 can further include a housing portion 340 provided with an inner space 340a accommodating the bearing portion 320.

Furthermore, the housing portion 340 can include a groove portion 341 defined to be recessed on one surface facing the rotating shaft 310 to fix one side of the sealing portion 330 while accommodating it.

The housing portion 340 can include a holder portion 321 disposed to surround an outer circumference of the bearing portion 320 to accommodate the bearing portion 320.

An O-ring 321b disposed to seal a gap existing between the holder portion 321 and the housing portion 340 can be provided between the holder portion 321 and the housing portion 340.

The O-ring 321b can be made of a rubber material, and can be provided in plural. An O-ring groove 321a, to which the O-ring 321b is inserted and fixed, can be defined on an outer surface of the holder portion 321.

The number of O-ring grooves 321a can be dispose to correspond to the number of O-rings 321b. In the drawings of the present disclosure, it is shown a case where two O-ring grooves 321a and O-rings 321b are respectively applied.

In addition, a snap ring 322 configured to support the bearing portion 320 and/or the holder portion 321 while being coupled to the housing portion 340 can be disposed at one side of the bearing portion 320 on a length direction (D1) of the rotating shaft 310.

The housing portion 340 can include a snap ring groove 342 in which part of one side of the snap ring 322 is disposed to be accommodated. Furthermore, the snap ring 322 can be made of a metal material.

In addition, the snap ring 322 can be defined to have a circular ring shape. The snap ring 322 can function to prevent the rotating shaft 310 and the bearing portion 320 from being separated from the housing portion 340.

The sealing portion 330 can be disposed adjacent to the bearing portion 320 on a length direction (D1) of the rotating shaft 310, and configured to constitute part of a movement path of the air (a) entering and leaving the gap 320a disposed between the rotating shaft 310 and the bearing portion 320.

In addition, the sealing portion 330 is disposed to block part of the air (a) flowing toward the gap 320a along a circumference of the rotating shaft 310.

The sealing portion 330 can be configured to include at least one of polytetrafluoroethylene (PTFE) and rubber. The PTFE can be made of DuPont's Teflon as a fluororesin.

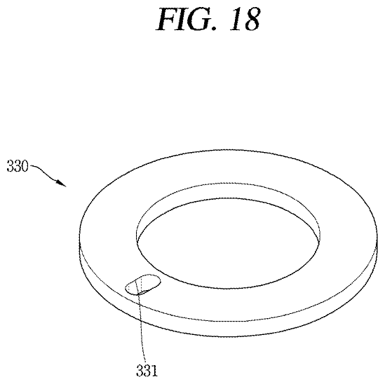

Referring to FIG. 16, the sealing portion 330 can be defined to have a circular ring shape. Furthermore, the sealing portion 330 can include a slit 331 as illustrated in FIGS. 17 and 18.

The slit 331 can be disposed to pass therethrough in a direction perpendicular to one surface facing the bearing portion 320. The slit 331 can constitute part of the movement path of the air (a).

The sealing portion 330 can be defined to have a C-shape disposed with the slit 331, as illustrated in FIG. 17.

In addition, the slit 331 can be defined to have a hole shape as illustrated in FIG. 18. The hole-shaped slits 331 can be provided in plural.

An example of the fan motor 300 to which the sealing portion 330 having the slit 331 is applied will be described later with reference to other drawings of the present disclosure.

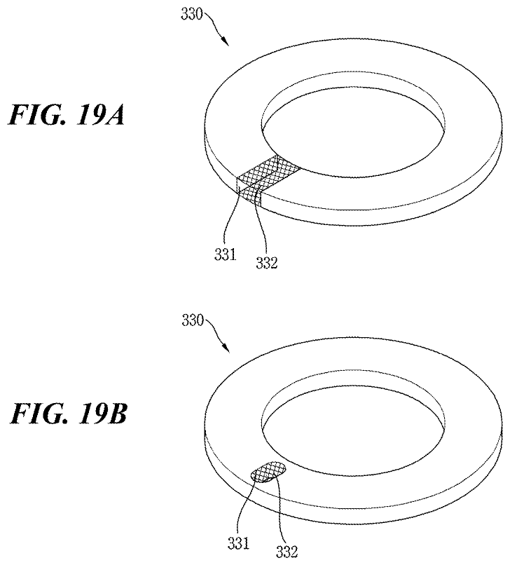

In some implementations, the sealing portion 330 can further include a mesh portion 332 as illustrated in FIGS. 19A and 19B.

The mesh portion 332 can be provided on the slit 331 provided in the sealing portion 330 to partition the movement path of the air (a) into a plurality of regions.

The mesh portion 332 can be made of the same type of material as the sealing portion 330, or can be made of a different type of material than the sealing portion 330.

According to the configuration of the mesh portion 332 as described above, part of the air (a) flowing into the gap 320a through the slit 331 can be made to collide with the mesh portion 332.

Accordingly, it can be possible to further lower the probability that foreign substances such as dust contained in the air (a) flow into the gap 320a.

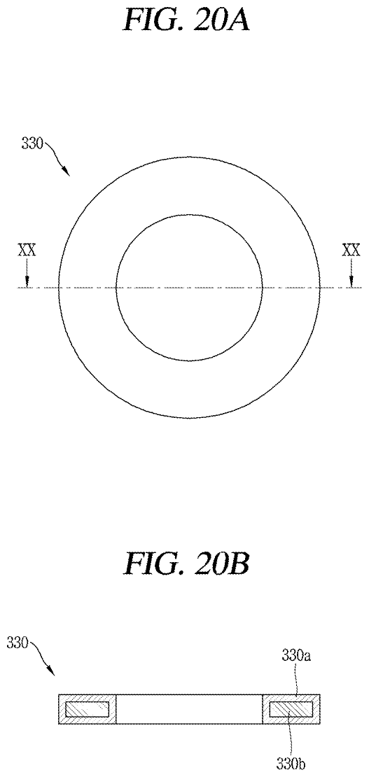

In some implementations, referring to FIGS. 20A and 20B, the sealing portion 330 can include a first portion 330a and a second portion 330b.

FIG. 20A is a conceptual view in which the sealing portion 330 is seen from the top, and FIG. 20B is a cross-sectional view taken along line XX-XX illustrated in FIG. 20A.

The first portion 330a can constitute part of the sealing portion 330 and can be made of a first material.

The second portion 330b can constitute another part of the sealing portion 330, and can be made of a second material different from the first material.

For example, the first portion 330a can be disposed to surround at least part of the second portion 330b, and the second material can be formed to have a greater rigidity than the first material.

For example, the first material can be made of any one of PTFE (polytetrafluoroethylene) and rubber, and the second material can be made of a metal material.

The first portion 330a and the second portion 330b can be implemented by double injection molding. In case where the type of the first material and/or the second material is a metal, a metal material in powder form can be used during the molding of the first and second portions 330a, 330b.

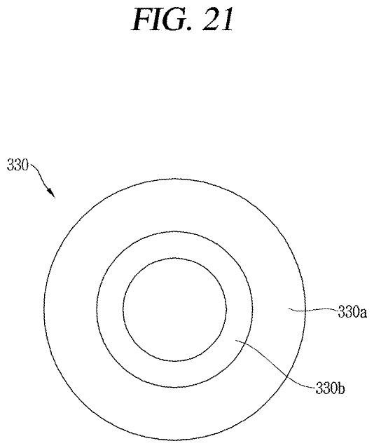

Furthermore, as illustrated in FIG. 21, the sealing portion 330 can include a first portion 330a constituting one side of the sealing portion 330, which is formed of the first material, and a second portion 330b formed of the second material different from the first material.

Here, the first portion 330a constituting one side of the sealing portion 330 can be configured to be accommodated in the groove portion 341 of the housing portion 340. In addition, the second portion 330b constituting the other side of the sealing portion 330 can define part of the movement path of the air (a).

For example, the first material constituting the first portion 330a can be made of a material having excellent properties to be fixed on the groove portion 341 of the housing portion 340, and the second material constituting the second portion 330b can be made of a material having a relatively low resistance to the flow of the air (a).

In other words, the first portion 330a of the sealing portion 330 can more stably maintain a state of being fixed to the housing portion 340 while the second portion 330b allows the air (a) entering and leaving the gap 320a to more efficiently flow, thereby more stably providing the performance of the bearing portion 320.

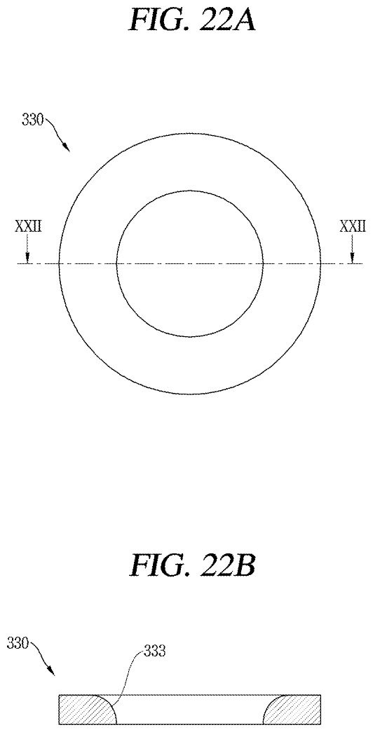

Furthermore, the sealing portion 330 can include a curved portion 333 as illustrated in FIGS. 22A and 22B. FIG. 22A is a conceptual view in which the sealing portion 330 is seen from the top, and FIG. 22B is a cross-sectional view taken along line XXII-XXII illustrated in FIG. 22A.

The curved portion 333 can be provided at the other side of the sealing portion 330 forming part of the movement path of the air (a), and configured to define a curved surface toward an the outer region of the gap 320a on a length direction (D1) of the rotating shaft 310.

In other words, the curved portion 333 can be defined along the first air current (a1) generated from the gap 320a toward an outside of the gap 320a in the air (a) entering and leaving the gap 320a.

An example of the fan motor 300 to which the sealing portion 330 having the curved portion 333 is applied will be described later with reference to other drawings of the present disclosure.

In some implementations, referring to FIG. 26, the sealing portion 330 can extend from the housing portion 340 toward the rotating shaft 310. In other words, the sealing portion 330 can be disposed to extend along a radial direction (D2) of the rotating shaft 310a in the housing portion 340.

In addition, one side of the sealing portion 330 can be fixed to the housing portion 340. In FIG. 26, it is shown a configuration in which one side of the sealing portion 330 is fixed and accommodated in the groove portion 341, but one side of the sealing portion 330 can be disposed to extend from one surface of the housing portion 340.

Furthermore, the other side of the sealing portion 330 can be spaced apart from the rotating shaft 310 at a predetermined distance to constitute part of the movement path of the air (a).

In addition, the sealing portion 330 can be provided above the bearing portion 320 or below the bearing portion 320 on a length direction (D1) of the rotating shaft 310. In FIG. 26, it is shown a configuration in which the sealing portion 330 is disposed under the bearing portion 320.

In addition, referring to FIG. 26, a gap formed between the rotating shaft 310 and the sealing portion 330 and a gap formed between the rotating shaft 310 and the bearing portion 320 can be different from each other.

Specifically, a first gap (g1) formed between the rotating shaft 310 and the other side of the sealing portion 330 facing the rotating shaft 310 can be defined to be smaller than a second gap (g2) formed between the rotating shaft 310 and one surface of the bearing portion 320 facing the rotating shaft 310.

For example, the first and second gaps (g1, g2) can be formed to satisfy a relation such as ‘g1=g2/2’.

Accordingly, the sealing portion 330 can be disposed to have the first gap (g1) defined to be smaller than the second gap (g2) to provide a gap for the flow of the air (a) for normal operation of the bearing portion 320, such as the first current (a1), to a minimum, while blocking air flowing into the gap 320a, such as the second air current (a2), to a maximum, thereby minimizing foreign substances such as dust from entering into the gap 320a.

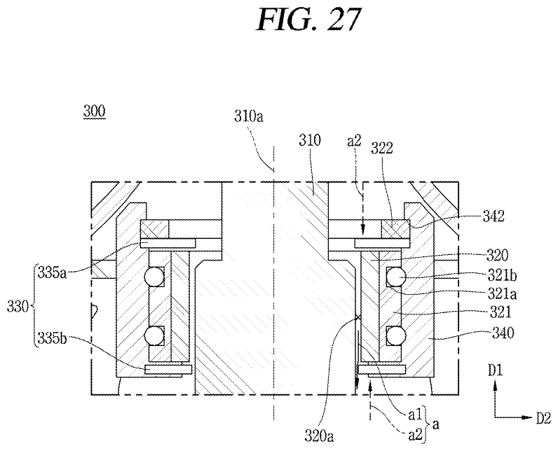

Hereinafter, other examples of the fan motor 300 illustrated in FIG. 26 will be described with further reference to FIGS. 27 through 34 along with FIGS. 14 through 26.

FIGS. 27 through 34 are conceptual views showing other examples of the fan motor 300 illustrated in FIG. 26.

First, referring to FIG. 27, the sealing portion 330 can be provided in plural, and can include an upper sealing member 335a and a lower sealing member 335b. The upper sealing member 335a and the lower sealing member 335b can be made of the same material or can be made of different materials.

The upper sealing member 335a can be provided at an upper side of the bearing portion 320 on a length direction (D1) of the rotating shaft 310. One side of the upper sealing member 335a can be disposed under the snap ring 322, and can be accommodated in and coupled to the snap ring groove 342 provided in the housing portion 340 together with the snap ring 322.

The lower sealing member 335b can be provided under the bearing portion 320 on a length direction (D1) of the rotating shaft 310. One side of the lower sealing member 335b can be accommodated in and fixed to the groove portion 341 provided in the housing portion 340.

In the air (a) entering and leaving the gap 320a, the second air current (a2) flowing into the gap 320a from an outer region of the gap 320a can be formed not only below the bearing portion 320, but also above the bearing portion 320.

According to the configuration of the upper sealing member 335a and the lower sealing member 335b, it can be configured to block part of the second air current (a2) generated in a direction flowing into the gap 320a formed between the bearing portion 320 and the rotating shaft 310 at both above and below the bearing portion 320, thereby minimizing foreign substances such as dust included in the second air current (a2) to flow into the gap 320a.

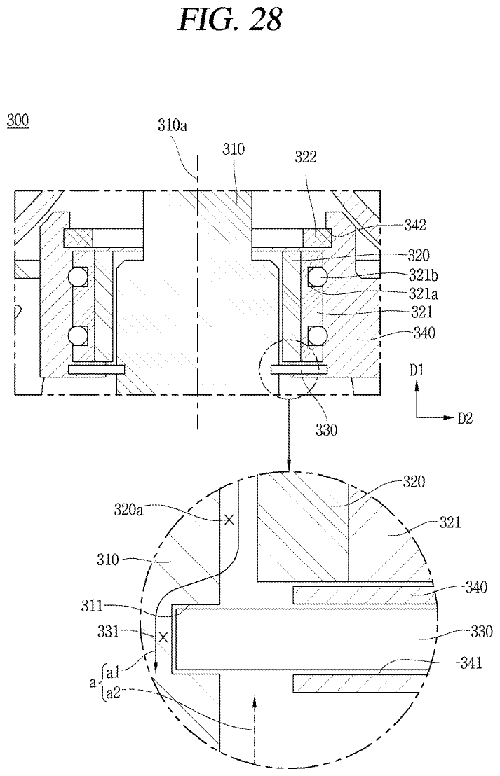

Next, referring to FIG. 28, one side of the sealing portion 330 can be fixed to the housing portion 340, and the other side of the sealing portion 330 can be accommodated in one side of the rotating shaft 310. The rotating shaft 310 can include a shaft groove 311 defined to be recessed on one surface of the rotating shaft 310 to accommodate the other side of the sealing portion 330.

Furthermore, one side of the sealing portion 330 can be fixed while being accommodated in the groove portion 341 provided on the housing portion 340.

Here, the sealing portion 330 can include a slit 331 disposed to pass therethrough in a direction perpendicular to one surface facing the bearing portion 320 to form part of the movement path of the air (a), as illustrated in FIGS. 17 and 18

In other words, the sealing portion 330 can be disposed to extend along a radial direction (D2) of the rotating shaft 310, and the slit 331 can be disposed on the sealing portion 330 to pass therethrough along a length direction (D1) of the rotating shaft 310.

Here, the air (a) entering and leaving the gap 320a formed between the bearing portion 320 and the rotating shaft 310 can be blocked by the sealing portion 330 excluding the slit 331.

In other words, air entering and leaving the gap 320a can flow through the slit 331. In addition, the second air current (a2) generated in a direction of flowing into the gap 320a in the air (a) can be blocked by the remaining portion of the sealing portion 330 except for the slit 331.

Furthermore, in the case of the sealing portion 330 provided with the slit 331 and defined to have a C-shape, deformation can be more easily carried out compared to the sealing portion 330 having a ring shape, thereby improving the operation efficiency of the process of assembling the sealing portion 330 to the groove portion 341 or the shaft groove 311.

In addition, in the case of the sealing portion 330 provided with the slit 331 defined to have a hole shape, compared to the sealing portion 330 having the C-shape, a region occupied by an empty space of the groove portion 341 or the shaft groove 311 in which one side and the other side of the sealing portion 330 are accommodated, respectively, can be small, thereby more stably maintaining a state in which the sealing portion 330 is coupled to the groove portion 341 or the shaft groove 311.

In some examples, a mesh portion 332 that partitions the movement path of the air (a) into a plurality of regions can be provided on the slit 331 of the sealing portion 330.

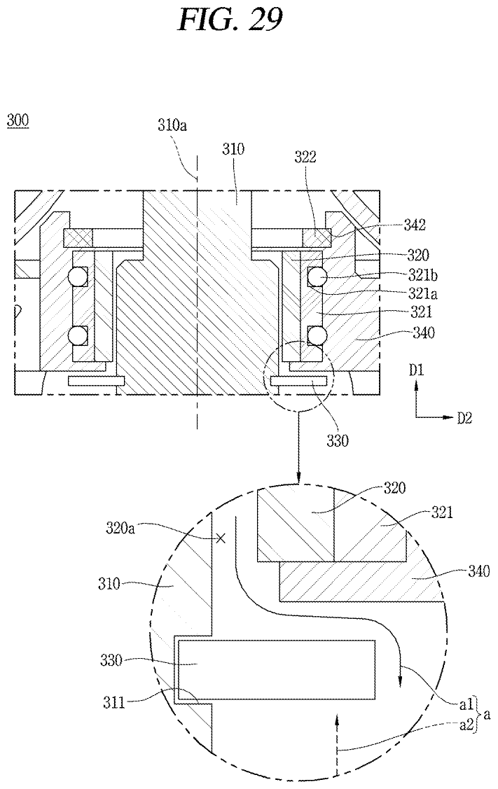

Next, referring to FIG. 29, one side of the sealing portion 330 can be fixed to the rotating shaft 310, and the other side of the sealing portion 330 can extend in a direction away from the rotating shaft 310.

Furthermore, the rotating shaft 310 can include the shaft groove 311 defined to be recessed on one surface of the rotating shaft 310 to fix one side of the sealing portion 330 while accommodating it. In addition, the other side of the sealing portion 330 can be configured to constitute part of the movement path of the air (a) entering and leaving the gap 320a, as illustrated in FIG. 29.

Furthermore, the sealing portion 330 can be made of the same type of material as the rotating shaft 310. For example, when the rotating shaft 310 is made of a metal material, the sealing portion 330 can be made of the same type of metal material as the rotating shaft 310.

Accordingly, even when the rotating shaft 310 rotating at high speed and the sealing portion 330 cause a phenomenon of sticking to each other, the operation of the bearing portion 320 and the function of the sealing portion can be normally carried out.

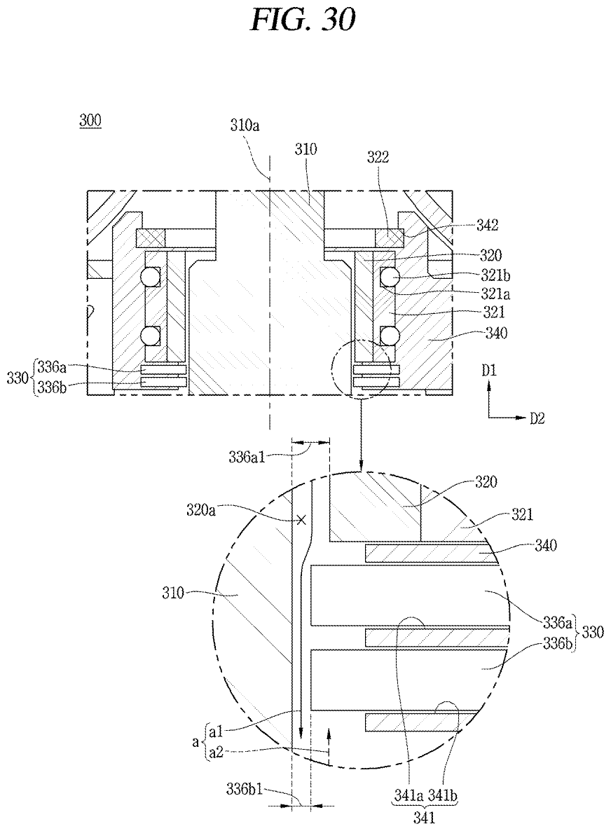

Next, referring to FIG. 30, the sealing portion 330 can be provided above or below the bearing portion 320 on a length direction (D1) of the rotating shaft 310.

In the case of the sealing portion 330 illustrated in FIG. 30, it is shown that the sealing portion 330 is provided under the bearing portion 320.

In addition, the sealing portion 330 can be provided in plural, and can be composed of a first sealing member 336a and a second sealing member 336b. Moreover, the first sealing member 336a can be disposed closer to the bearing portion 320 than the second sealing member 336b on a length direction (D1) of the rotating shaft 310.

In FIG. 30, the first and second sealing members 336a, 336b are shown to be disposed under the bearing portion 320, but can be disposed above the bearing portion 320 instead of therebelow.

Here, a first sealing gap 336a1 formed between the rotating shaft 310 and the other side of the first sealing member 336a facing the rotating shaft 310, and a second sealing gap 336b1 formed between the rotation shaft 310 and the other side of the second sealing member 336b facing the rotating shaft 310 can be formed to be the same.

One side of the first and second sealing members 336a, 336b can be fixed while being accommodated in the first groove 341a and the second groove 341b respectively defined to be recessed on one surface of the housing portion 340.

Lengths of the first and second sealing members 336a, 336b in a radial direction (D2) of the rotating shaft 310 can be defined to be different from each other.

At this time, the first groove 341a and the second groove 341b can be disposed to have different depths recessed on one surface of the housing portion 340, thereby forming the first and second sealing gaps 336a1, 336b1 to be the same.

According to the configuration of the first and second sealing members 336a, 336b, a region resisting the second air current (a2) generated in a direction flowing into the gap 320a in the air (a) entering and leaving the gap 320a can be increased to minimize a probability that foreign substances such as dust included in the second air current (a2) flow into the gap 320a.

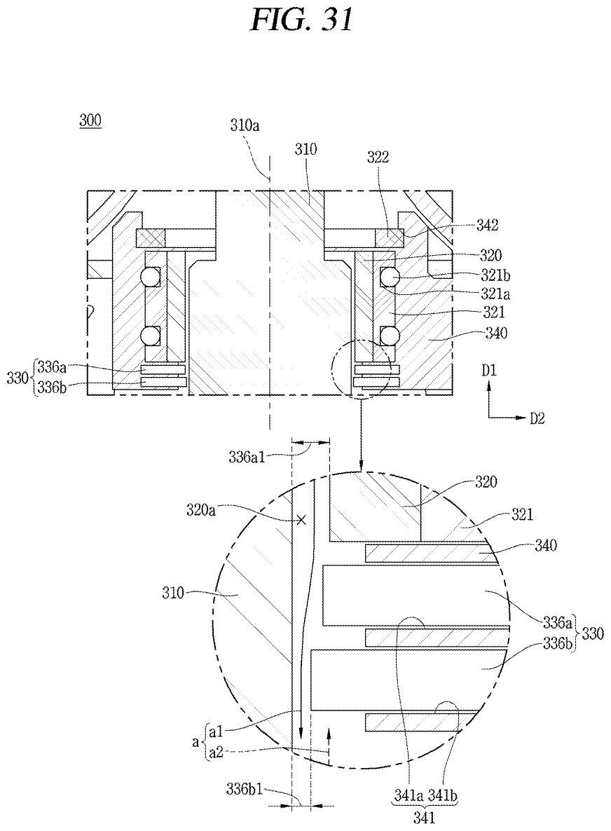

Next, referring to FIG. 31, similar to the fan motor 300 illustrated in FIG. 30, the sealing portion 330 can be provided in plural to include a first sealing member 336a and a second sealing member 336b.

Here, in the case of the first and second sealing members 336a, 336b illustrated in FIG. 31, a first sealing gap 336a1 formed between the rotating shaft 310 and the other side of the first sealing member 336a facing the rotating shaft 310, and a second sealing gap 336b1 formed between the rotation shaft 310 and the other side of the second sealing member 336b facing the rotating shaft 310 can be formed to be different from each other.

For example, as illustrated in FIG. 31, the second sealing gap 336b1 can be formed to be smaller than the first sealing gap 336a1.

According to the configuration of the first and second sealing members 336a, 336b as described above, by the second sealing member 336b disposed at an upstream side of the first sealing member 336a with respect to a flow direction of the second air current (a2) in the air (a) entering and leaving the gap 320a, the first air current (a1) generated from the gap 320a to an outer region of the gap 320a can be efficiently formed to a maximum while minimizing a region in which the second air current (a2) flows into the gap 320a, thereby more stably providing the operation of the bearing portion 320.

In other words, the first sealing gap 336a1 can be formed to be relatively larger than the second sealing gap 336a2, thereby reducing a region resisting the first air current (a1) in the first and second sealing members 336a, 336b.

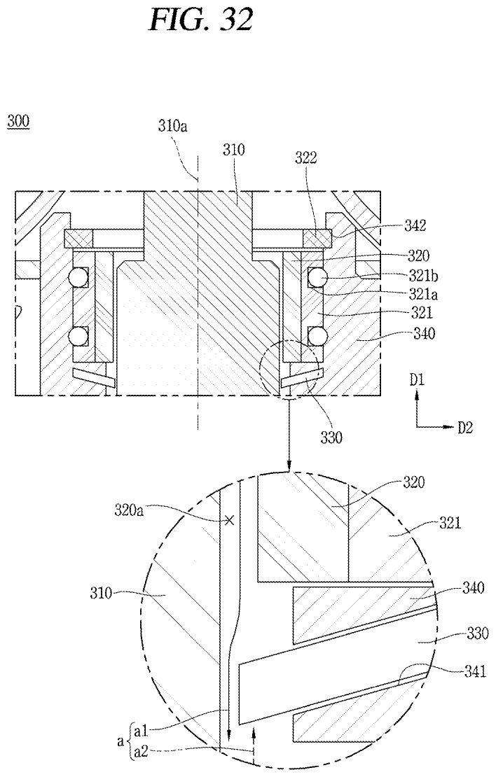

Next, referring to FIG. 32, the groove portion 341 provided in the housing portion 340 can be disposed to be inclined toward an outer region of the gap 320a on a length direction (D1) of the rotating shaft 310.

Here, one side of the sealing portion 330 can be accommodated in the groove portion 341 of the housing portion 340 to extend obliquely toward the outer region of the gap 320a on the length direction (D1) of the rotating shaft 310.

According to the configuration of the groove portion 341 and the sealing portion 330 as described above, the other side of the sealing portion 330 forming the movement path of the air (a) can be disposed to face an outer region of the gap 320a to more efficiently perform the movement of the first air current (a1) generated toward an outer region of the gap 320a in the air (a) entering and exiting the gap 320a, thereby more stably perform the operation of the bearing portion 320.

In addition, when foreign substances such as dust flow into the gap 320a, the foreign substances such as dust can be discharged more quickly to the outer region of the gap 320a again by the first air current (a1).

In some examples, in the case of the second air current (a2) generated toward the gap 320a, the sealing portion 330 can be defined to be inclined in a direction opposite to the second air current (a2) so as to further increase resistance to the second air current (a2), thereby further reducing the probability that the second air current (a2) flows into the gap 320a.

In other words, due to the structure of the sealing portion 330, it can be possible to minimize a phenomenon in which foreign substances such as dust move together with the second air current (a2) to flow into the gap 320a.

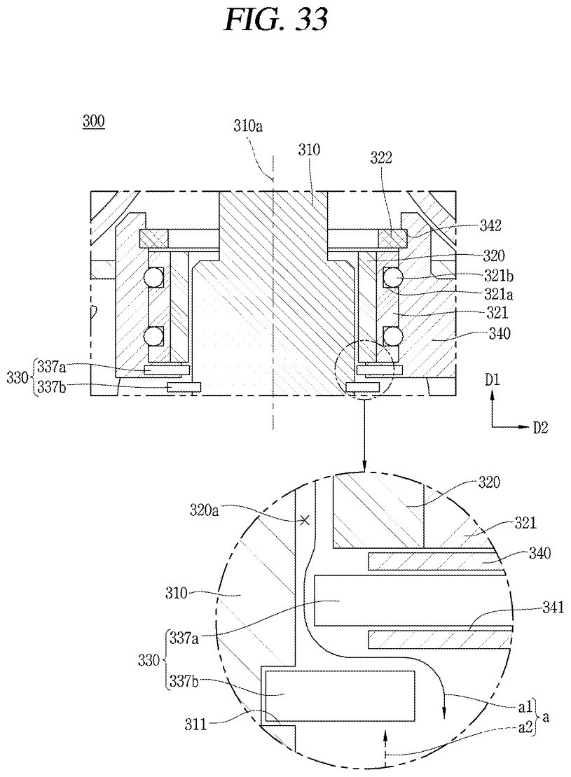

Next, referring to FIG. 33, the sealing portion 330 can be provided in plural, and can include a housing sealing member 337a and a shaft sealing member 337b.

The housing sealing member 337a can be disposed to extend from the housing portion 340 toward the rotating shaft 310, and one side of the housing sealing member 337a can be fixed to the housing portion 340, and the other side of the housing sealing member 337a can be spaced apart from the rotating shaft 310 at a predetermined distance. One side of the housing sealing member 337a can be fixed while being accommodated in a groove portion 341 provided in the housing portion 340.

One side of the shaft sealing member 337b can be fixed to the rotating shaft 310a, and the other side thereof can extend in a direction away from the rotating shaft 310.

In addition, the shaft sealing member 337b can be configured to form part of the movement path of the air (a) entering and leaving the gap 320a together with the housing sealing member 337a. One side of the shaft sealing member 337b can be fixed while being accommodated in the shaft groove 311 provided in the rotating shaft 310.

As such, the housing sealing member 337a and the shaft sealing member 337b can be alternately disposed on the right and left, respectively, on a length direction (D1) of the rotating shaft 310.

Accordingly, it is shown a movement in which the second air current (a2) generated toward the gap (320a) in the air (a) entering and leaving the gap 320a first passes through the other side of the shaft sealing member 337b, and then passes through the other side of the housing sealing member 337a.

Here, the other side of the housing sealing member 337a and the other side of the shaft sealing member 337b that form part of the movement path of the air (a) can be alternately disposed from each other, thereby making the movement of the second air current (a2) flowing into the gap (320a) to be more difficult.

In other words, due to the structure of the housing sealing member 337a and the shaft sealing member 337b, it can be possible to greatly reduce the probability that foreign substances such as dust move together with the second air current (a2) to flow into the gap 320a.

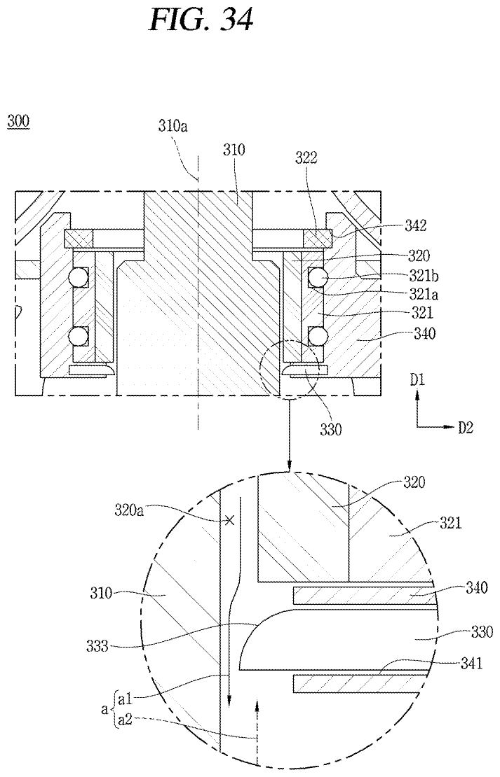

Finally, referring to FIG. 34, the other side of the sealing portion 330 can form part of the movement path of the air (a) entering and leaving the gap 320a formed between the bearing portion 320 and the rotating shaft 310.

Here, the sealing portion 330 can include a curved portion 333.

As illustrated in FIGS. 22A and 22B, the curved portion 333 can be provided at the other side (inner side) of the sealing portion 330 forming the movement path of the air (a) to form a curved surface toward an outer region of the gap 320a on a length direction (D1) of the rotation shaft 310.

According to the configuration of the sealing portion 330 having the curved portion 333 as described above, the movement of the first air current (a1) generated toward the outer region of the gap 320a in the air (a) entering and leaving the gap 320a can be more efficiently carried out along the curved portion 333.

In other words, part of the air (a) flowing toward the gap 320a can be blocked by the sealing portion 330 to prevent foreign substances such as dust from flowing into the gap 320a, and the flow of the air (a) flowing through the gap 320a can be formed more stably to further improve the operation reliability of the bearing portion 320.

What is claimed is:

1. A fan motor, comprising:
a shroud that defines a suction port at an upstream end portion of the shroud and a first discharge port at a downstream end portion of the shroud, the shroud being configured to guide air along a flow direction from the upstream end portion to the downstream end portion;
a rotating shaft rotatably disposed inside the shroud, the rotating shaft comprising:
a first support portion and a second support portion that are spaced apart from each other in an axial direction of the rotating shaft, and
a permanent magnet mounting portion disposed between the first support portion and the second support portion;
an impeller disposed at a first end portion of the rotating shaft;
an air bearing disposed adjacent to the impeller and configured to rotatably support the first support portion, the air bearing defining an air gap facing the first support portion;
a permanent magnet disposed at the permanent magnet mounting portion, wherein the permanent magnet is disposed between the first end portion and a second end portion of the rotating shaft opposite to the first end portion in the axial direction; and
a ball bearing disposed at the second end portion of the rotating shaft and configured to rotatably support the second support portion.

2. The fan motor of claim 1, wherein the air bearing comprises a polyaryletherketone (PAEK) material or a polyetheretherketone (PEEK) material.

3. The fan motor of claim 1, where the air bearing defines an O-ring mounting groove on an outer circumferential surface of the air bearing along a circumferential direction, and
wherein the fan motor further comprises an O-ring disposed in the O-ring mounting groove.

4. The fan motor of claim 1, wherein the air bearing defines a plurality of O-ring mounting grooves that are spaced apart from one another in the axial direction, and
wherein the fan motor further comprises a plurality of O-rings disposed in the O-ring mounting grooves, respectively.

5. The fan motor of claim 1, wherein an inner diameter of the air bearing is greater than a length of the air bearing in the axial direction.

6. The fan motor of claim 1, further comprising a stator core that surrounds the permanent magnet,
wherein an inner diameter of the air bearing is less than an inner diameter of the stator core.

7. The fan motor of claim 1, wherein a diameter of the first support portion is greater than a diameter of the second support portion.

8. The fan motor of claim 1, wherein a diameter of the first support portion is greater than a diameter of the permanent magnet mounting portion.

9. The fan motor of claim 1, further comprising:
an O-ring holder that surrounds the ball bearing, the O-ring holder defining a plurality of O-ring mounting grooves on an outer wall of the O-ring holder; and
a plurality of O-rings disposed in the plurality of O-ring mounting grooves, respectively.

10. The fan motor of claim 1, wherein the impeller comprises:
a hub that overlaps with the air bearing in the axial direction and covers the air bearing; and
a plurality of blades that protrude from an outer circumferential surface of the hub.

11. The fan motor of claim 1, further comprising:
a stator comprising a stator core that surrounds the permanent magnet and is spaced apart from the permanent magnet, and a stator coil wound around the stator core;
a first bearing receiving portion that is defined between the impeller and the stator and accommodates the air bearing;
a motor housing that surrounds the stator core and is disposed downstream relative to the first bearing receiving portion in the flow direction;
a vane hub disposed inside the shroud, the vane hub having a first side that surrounds the first bearing receiving portion, and a second side that surrounds the motor housing;
a plurality of vanes that protrude from an outer circumferential surface of the vane hub and are coupled to an inner circumferential surface of the shroud; and
a second bearing receiving portion that is defined inside the motor housing and accommodates the ball bearing.

12. The fan motor of claim 11, further comprising:
an outer passage defined between the shroud and the vane hub, the out passage having an annular shape and being configured to transfer a part of air suctioned by the impeller from the suction port to the first discharge port; and
an inner passage disposed inside the vane hub and the motor housing,
wherein the vane hub defines a plurality of communication holes that are in fluid communication with the outer passage and the inner passage, the plurality of communication holes being configured to receive another part of the air suctioned by the impeller from an upstream side of the outer passage into the inner passage.

13. The fan motor of claim 12, further comprising:
a plurality of first bridges that extend from an upper end of the motor housing to the first bearing receiving portion, the plurality of first bridges connecting the first bearing receiving portion and the motor housing to each other; and
a plurality of second bridges that extend in a radial direction away from an outer circumferential surface of the second bearing receiving portion toward an inner circumferential surface of the motor housing, the plurality of second bridges connecting the motor housing and the second bearing receiving portion to each other,
wherein the motor housing defines a plurality of second discharge ports that are in fluid communication with the inner passage and configured to discharge air guided along the inner passage, wherein one of the plurality of second discharge ports is positioned between two of the plurality of second bridges.

14. The fan motor of claim 13, wherein the plurality of second bridges define a plurality of fastening grooves, respectively,
wherein the motor housing defines a plurality of fastening holes, each of the plurality of fastening holes overlapping with one of the plurality of fastening grooves in a radial direction, and
wherein the motor housing and the plurality of second bridges are coupled to each other by a plurality of fastening members that are fastened to the plurality of fastening grooves through the plurality of fastening holes, respectively.

15. The fan motor of claim 13, further comprising:
a plurality of fastening portions that protrude in a radial direction away from an outer circumferential surface of the motor housing toward an inner circumferential surface of the shroud, the plurality of fastening portions coupling the shroud and the motor housing to each other,
wherein the motor housing and the shroud define a plurality of first discharge ports between the plurality of fastening portions.

16. The fan motor of claim 15, wherein the plurality of fastening portions and the plurality of second bridges are alternately arranged and spaced apart from each other in a circumferential direction of the motor housing such that each of the plurality of fastening portions and each of the plurality of second bridges do not to overlap with each other in a radial direction of the motor housing.

17. The fan motor of claim 1, further comprising:
a first O-ring holder that is disposed at an outer circumferential surface of the air bearing and surrounds the air bearing, the first O-ring holder defining a plurality of first O-ring mounting grooves;
a plurality of first O-rings disposed in the plurality of first O-ring mounting grooves, respectively;
a second O-ring holder that is disposed at an outer circumferential surface of the ball bearing and surrounds the ball bearing, the second O-ring holder defining a plurality of second O-ring mounting grooves; and
a plurality of second O-rings disposed in the plurality of second O-ring mounting grooves, respectively.

18. The fan motor of claim 1, wherein the air bearing comprises a sealing portion that surrounds a part of the rotating shaft, the sealing portion having a first surface that faces the rotating shaft and that is spaced apart from the rotating shaft to thereby define a gap at a predetermined distance from the rotating shaft, the gap being configured to allow flow of air therethrough, and
wherein the sealing portion is arranged adjacent to the air bearing in the axial direction and extends along a circumference of the rotating shaft, the sealing portion being configured to block part of the air passing through the gap.

19. The fan motor of claim 18, further comprising a housing portion having an inner space that accommodates the air bearing therein,
wherein the sealing portion extends in a radial direction from the housing portion toward the rotating shaft, the sealing portion having a first side fixed to the housing portion, and a second side spaced apart from the rotating shaft to thereby define a flow path of air at a preset distance from the rotating shaft.

20. The fan motor of claim 19, wherein the sealing portion is disposed vertically above or below the air bearing in the axial direction.
